(19) United States
(12) Patent Application Publication
(10) Pub. No.: US 2013/0309946 A1
(43) Pub. Date: Nov. 21, 2013

(54) METHOD FOR MANUFACTURING MAGNETIC DISC SUBSTRATE

(71) Applicant: Takeshi Hamaguchi, Wakayama-shi (JP)

(72) Inventor: Takeshi Hamaguchi, Wakayama-shi (JP)

(73) Assignee: KAO CORPORATION, Tokyo (JP)

(21) Appl. No.: 13/982,978

(22) PCT Filed: Jan. 18, 2012
(86) PCT No.: PCT/JP2012/050993

§ 371 Date: Jul. 31, 2013

(30) Foreign Application Priority Data
Jan. 31, 2011 (JP) 2011-018680
Dec. 28, 2011 (JP) 2011-289756

(51) Int. Cl. G11B 5/84; B24B 37/04

(52) U.S. Cl. CPC G11B 5/84; B24B 37/048; B24B 37/044
USPC 451/59

(57) ABSTRACT

A magnetic disk substrate production method by which the embedded alumina can be reduced is provided. The magnetic disk substrate production method includes the steps of (1) polishing a polishing surface of a substrate to be polished using a polishing liquid composition A containing alumina particles and water; (2) polishing the polishing surface of the substrate obtained in the step (1) using a polishing liquid composition B containing water and silica particles having an average primary particle size (D50) of 5 to 60 nm and a primary particle size standard deviation of less than 40 nm; (3) cleaning the substrate obtained in the step (2); and (4) polishing the polishing surface of the substrate obtained in the step (3) using a polishing liquid composition C containing silica particles and water.

### TECHNICAL FIELD

The present invention relates to a method for producing a magnetic disk substrate and a method for polishing a magnetic disk substrate.

### BACKGROUND ART

As magnetic disk drives have become smaller in size and have grown in capacity in recent years, there is a need to increase their recording densities. In order to increase the recording density, it is necessary to reduce the unit recording area to improve the detection sensitivity to weakened magnetic signals. For this reason, the development of techniques for further reducing the flying height of magnetic heads has been pursued. To reduce the flying height of magnetic heads and to secure the recording area, the requirements for magnetic disk substrates become increasingly stringent, with regard to the improvement of smoothness and flatness (reductions in surface roughness, waviness, and roll-off) and the reduction in surface defects (reductions in residual abrasive grains, scratches, protrusions, pits, etc.).

In order to meet such requirements, a multistage polishing method including two or more polishing steps is adopted in many cases to produce hard disk drives in terms of improving both the productivity and the surface quality such as better smoothness and less scratches. To meet requirements such as reductions in flaws such as surface roughness, scratches, protrusions and pits, a polishing liquid composition for final polishing containing colloidal silica particles is typically used in the last polishing step of the multistage polishing method, in other words, in the final polishing step, and a polishing liquid composition containing alumina particles is used in polishing steps prior to the final polishing step (also referred to as rough polishing steps) in terms of improving the productivity (e.g., Patent Document 1).

When alumina particles are used as abrasive grains, they become embedded in the substrates, causing texture scratches. Texture scratches may lead to medium defects. In order to solve such a problem, there has been proposed a magnetic disk substrate production method including the steps of: rough-polishing a substrate under a predetermined polishing down force using a polishing liquid composition containing an acid and aluminum oxide particles having an average secondary particle size of 0.1 to 0.7 μm; and final-polishing the substrate obtained in the rough polishing step for a predetermined polishing amount using a polishing liquid composition containing colloidal particles (e.g., Patent Document 2).

A polishing liquid composition containing alumina particles having a certain particle size and silica particles with a certain particle size distribution is proposed recently as a technique of further reducing the embedded alumina particles in substrates (e.g., Patent Document 3).

Further, as a surface roughness reduction technique, a technique of performing polishing in two stages using alumina particles is proposed (e.g., Patent Document 4), and a technique of performing polishing in two stages specifically using ceria is proposed to simplify the polishing steps (e.g., Patent Document 5).

### PRIOR ART DOCUMENTS

### Patent Documents

Patent Document 1: JP 2005-63530 A
Patent Document 2: JP 2007-168057 A
Patent Document 3: JP 2009-176397 A
Patent Document 4: JP S63-260762 A
Patent Document 5: JP 2006-95677 A

### DISCLOSURE OF INVENTION

### Problem to be Solved by the Invention

As magnetic disk drives have grown in capacity, characteristics required of the substrates in terms of the surface quality have become increasingly stringent. Therefore, there is a need in a magnetic disk substrate production process to further reduce alumina particle residues on substrates such as embedded alumina.

With the foregoing in mind, the present invention provides a magnetic disk substrate production method by which the embedded alumina particles in the substrate surface following the rough polishing steps and protrusion defects of the substrate surface following the final polishing step can be reduced.

### Means for Solving Problem

Viewed from one aspect, the present invention relates to a method for producing a magnetic disk substrate (hereinafter also referred to as “the substrate production method of the present invention), which includes the steps of:

(1) supplying a polishing liquid composition A containing alumina particles and water to a polishing surface of a substrate to be polished, and polishing the polishing surface by brining a polishing pad into contact with the polishing surface and moving the polishing pad and/or the substrate to be polished (hereinafter also referred to as “the step (1)”);

(2) supplying to the polishing surface of the substrate obtained in the step (1) a polishing liquid composition B containing water and silica particles having an average primary particle size (D50) of 5 to 60 nm and a primary particle size standard deviation of less than 40 nm, and polishing the polishing surface by brining a polishing pad into contact with the polishing surface and moving the polishing pad and/or the substrate to be polished (hereinafter also referred to as “the step (2)”);

(3) cleaning the substrate obtained in the step (2) (hereinafter also referred to as “the step (3)”); and

(4) supplying a polishing liquid composition C containing silica particles and water to the polishing surface of the substrate obtained in the step (3), and polishing the polishing surface by brining a polishing pad into contact with the polishing surface and moving the polishing pad and/or the substrate to be polished (hereinafter also referred to as “the step (4)”).

Viewed from another aspect, the present invention relates to a method for polishing a magnetic disk substrate (hereinafter also referred to as “the polishing method of the present invention), which includes the steps of:

(1) supplying a polishing liquid composition A containing alumina particles and water to a polishing surface of a substrate to be polished, and polishing the polishing surface by brining a polishing pad into contact with the polishing surface and moving the polishing pad and/or the substrate to be polished;

(2) supplying to the polishing surface of the substrate obtained in the step (1) a polishing liquid composition B containing water and silica particles having an average primary particle size (D50) of 5 to 60 nm and a primary particle size standard deviation of less than 40 nm, and polishing the polishing surface by brining a polishing pad into contact with the polishing surface and moving the polishing pad and/or the substrate to be polished;

(3) cleaning the substrate obtained in the step (2); and

(4) supplying a polishing liquid composition C containing silica particles and water to the polishing surface of the substrate obtained in the step (3), and polishing the polishing surface by brining a polishing pad into contact with the polishing surface and moving the polishing pad and/or the substrate to be polished.

### Effects of the Invention

According to the present invention, substrates can be produced in an efficient manner while reducing the embedded alumina following the rough polishing steps and protrusion defects following the final polishing step, so that magnetic disk substrates of improved substrate quality can be produced productively.

### DESCRIPTION OF THE INVENTION

When a magnetic disk substrate production method includes two rough polishing steps, one using a polishing liquid composition A containing alumina particles and water and the other using a polishing liquid composition B containing certain silica particles and water, and further includes, following cleaning of a rough polished substrate, a final polishing step using a polishing liquid composition C containing silica particles and water, the embedded alumina in the substrate following the rough polishing steps and protrusion defects of the substrate following the final polishing step can be reduced. The present invention is based on such findings.

The term “embedded alumina” as used herein refers to the embedded alumina particles in a substrate resulting from polishing the substrate using the alumina particles as an abrasive. Further, the term “protrusion defects” as used herein refers to polishing waste produced during polishing such as waste of polishing particles such as alumina. The number of embedded alumina particles and/or protrusion defects can be evaluated by observation of a polished substrate surface using a microscope, a scanning electron microscope, or a surface defect detector.

It is not clear as to why the use of the substrate production method of the present invention can effectively reduce the embedded alumina following the rough polishing steps and protrusion defects following the final polishing step. However, it can be assumed that the use of silica particles having a certain average primary particle size in the step (2) as the second rough polishing step leads to an increase in fractional force during polishing/cutting, thereby effectively pulling out alumina particles embedded in a substrate during the step (1) and reducing the embedded alumina in the substrate. Further, it can be assumed that the use of silica particles having a certain particle size and standard deviation in the step (2) results in the effective development of fractional force during polishing/cutting, reducing the embedded alumina in a substrate. Moreover, it can be assumed that as a result of performing the step (4) as the final polishing step after cleaning the substrate rough polished in the step (3), less alumina particles are carried into the final polishing step, further reducing the embedded alumina. However, the present invention is not limited to these mechanisms.

Generally, magnetic disks are produced by rough-polishing and final-polishing fine ground glass substrates, Ni—P plated aluminum alloy substrates or the like, and forming a recording portion on the substrates. A rinsing step or cleaning step may be included between the polishing steps.

[Substrate to be Polished]

The substrate to be polished used in the substrate production method of the present invention is a magnetic disk substrate or a substrate used for a magnetic disk substrate. Specific examples of such a substrate include an Ni—P plated aluminum alloy substrate and glass substrates made of silicate glass, aluminosilicate glass, crystallized glass and tempered glass. In particular, an Ni—P plated aluminum alloy substrate is preferred as the substrate to be polished of the present invention.

The shape of the substrate to be polished is not particularly limited, and the substrate may have a disk-shaped, plate-shaped, slab-shaped or prism-shaped planar portion, or a curved portion such as a lens. In particular, a disk-shaped substrate to be polished is suitable. A disk-shaped substrate to be polished has an outer diameter of, for example, about 2 to 95 mm and a thickness of, for example, about 0.5 to 2 mm.

[Step (1): First Rough Polishing]

The substrate production method of the present invention includes the step of supplying a polishing liquid composition A containing alumina particles and water to a polishing surface of a substrate to be polished, and polishing the polishing surface by brining a polishing pad into contact with the polishing surface and moving the polishing pad and/or the substrate to be polished (step (1)). A polisher used in the step (1) is not particularly limited, and a known polisher for polishing magnetic disk substrates can be used.

As a way to polish a substrate to be polished using the polishing liquid composition A, the substrate to be polished is sandwiched between platens equipped with a polishing pad, such as an organic polymer-based polishing cloth in the form of nonwoven fabric, and the substrate to be polished is polished by moving the platens and the substrate to be polished, while supplying the polishing liquid composition of the present invention to a polisher.

The step (1) is performed prior to the step (2) (described later). In terms of reducing the embedded alumina and preventing alumina from being carried into the final polishing step, it is preferable that the step of rinsing the substrate obtained in the step (1) (intermediate rising step) is performed between the steps (1) and (2). Also, in view of the productivity, it is preferable that the rinsing step is performed in the same polisher as the one used in the step (1) without taking out the substrate to be polished from the polisher. A rinse solution used in the rinsing step is not particularly limited but water such as distilled water, ion exchanged water, pure water, or ultrapure water may be used in terms of production cost. Further, in terms of improving the productivity, it is preferable that the step of cleaning the substrate obtained in the step (1) (e.g., cleaning step such as the step (3) (described later)) is not performed between the steps (1) and (2). The polisher used in the step (1) is not particularly limited, and a known polisher for polishing magnetic disk substrates can be used. Specific examples of the rinsing step may include supplying a rinse solution to a polishing surface of a substrate to be polished and rinsing the polishing surface by moving the substrate to be polished. The term “rinsing” as used herein refers to a process for removing abrasive grains and swarf remaining on the substrate surface and it is performed by supplying a rinse solution to the substrate to be polished being attached to the polisher. Further, the term “rinsing” as used herein refers to a different process from polishing a substrate surface using abrasive grains while dissolving the substrate surface to flatten the substrate surface (chemical machine polishing).

[Step (2): Second Polishing Step]

The substrate production method of the present invention includes the step of supplying to the polishing surface of the substrate obtained in the step (1) the polishing liquid composition B containing water and silica particles having an average primary particle size (D50) of 5 to 60 nm and a primary particle size standard deviation of less than 40 nm, and polishing the polishing surface by brining a polishing pad into contact with the polishing surface and moving the polishing pad and/or the substrate to be polished (step (2)).

The step (2) is performed after the step (1) and prior to the step (3) (described later). In terms of reducing the embedded alumina and preventing alumina from being carried into the final polishing step, it is preferable that the step of rinsing the substrate to be polished is also performed after the step (2). Further, in terms of improving the productivity, reducing the embedded alumina, and preventing alumina from being carried into the final polishing step, it is preferable to use in the step (2) the same polisher as that used in the step (1). Here, “the same polisher as that used in the step (1)” means that one polisher is used in the steps (1) and (2) to polish the substrate to be polished. A polishing pad, the supply rate of the polishing liquid composition and the method for supplying the polishing liquid composition to the polisher used in the step (2) are the same as in the step (1).

[Step (3): Cleaning]

In terms of reducing the embedded alumina and preventing alumina from being carried into the final polishing step, the substrate production method of the present invention includes the step of cleaning the substrate obtained in the step (2) (step (3)). In the step (3), it is preferable to use a detergent composition to clean the rough polished substrate as the substrate to be cleaned. The step (3) is performed after the aforementioned step (2) and prior to the step (4) (described later). In the step (3), the detergent composition is supplied to the surface of the substrate obtained in the step (2) by (a) immersing the substrate in the detergent composition and/or (b) injecting the detergent composition.

In the aforementioned procedure (a), conditions of immersing the substrate in the detergent composition are not particularly limited, and for example, the temperature of the detergent composition is preferably 20 to 100° C., and more preferably 20 to 60° C. in terms of safety and operability, and the immersion time is preferably 10 seconds to 30 minutes, and more preferably 2 to 20 minutes in terms of the cleaning property of the detergent composition and production efficiency. In addition, in terms of enhancing residue removability and residue dispersibility, it is preferable to apply ultrasonic vibrations to the detergent composition. The ultrasonic frequency is preferably 20 to 2,000 kHz, more preferably 40 to 2,000 kHz, and still more preferably 40 to 1,500 kHz.

In the aforementioned procedure (b), in terms of promoting residue cleaning property and oil dissolvability, it is preferable to clean the surface by bringing the detergent composition into contact with the surface of the substrate by injecting the detergent composition to which ultrasonic vibrations are applied, or to clean by injecting the detergent composition onto the surface of the substrate to be cleaned and then by rubbing with a cleaning brush the surface provided with the detergent composition. It is further preferable to clean by supplying the detergent composition applied with ultrasonic vibrations to the surface of the object to be cleaned by injection and rubbing with a cleaning brush the surface provided with the detergent composition.

A known means such as a spray nozzle or the like can be used as a means to supply the detergent composition onto a surface of a substrate to be cleaned. Moreover, a cleaning brush is not particularly limited, and for example, known brushes such as a nylon brush, a PVA (polyvinyl alcohol) sponge brush and the like can be used. It is sufficient that the ultrasonic frequency is represented by the same values as those preferably selected in the procedure (a) described above.

The step (3) may include, in addition to the aforementioned procedure (a) and/or the aforementioned procedure (b), one or more steps in which known cleaning such as swinging-cleaning, cleaning using the rotation of a spinner or the like, paddle cleaning, etc., is used.

[Step (4): Final Polishing]

The substrate production method of the present invention includes the step of supplying the polishing liquid composition C containing silica particles and water to the polishing surface of the substrate obtained in the step (3), and polishing the polishing surface by brining a polishing pad into contact with the polishing surface and moving the polishing pad and/or the substrate to be polished (step (4)).

The step (4) is performed after the step (3). In terms of preventing alumina from being carried into the final polishing step and reducing protrusion defects of the substrate following the final polishing step, a polisher to be used in the step (4) is preferably different from the one used in the steps (1) and (2). Here, “a polisher different from the one used in the steps (1) and (2)” refers to a different polisher from the one used in the steps (1) and (2). The supply rate of the polishing liquid composition C, and the method for supplying the polishing liquid composition C to the polisher used in the step (4) are the same as those used in the step (1).

Since the substrate production method of the present invention includes the first rough polishing step (1), the second rough polishing step (2), the cleaning step (3), and the final polishing step (4), the embedded alumina into the substrate and the waviness of the substrate surface following the rough polishing steps and protrusion defects of the substrate and the waviness of the substrate surface following the final polishing step are reduced effectively.

[Polishing Pads in Steps (1) and (2)]

Polishing pads used in the steps (1) and (2) are not particularly limited, and polishing pads such as suede type, nonwoven fabric type, or polyurethane closed-cell type polishing pads, or two-layer type polishing pads in which such polishing pads are laminated can be used. However, in terms of improving the polishing removal rate, suede type polishing pads are preferred. A suede type polishing pad is composed of a base layer and a foamed layer having spindle-shaped pores disposed perpendicular to the base layer. The material of the base layer may be nonwoven fabric made of natural fibers such as cotton or artificial fibers or one obtained by charging a rubber material such as styrene butadiene rubber. In terms of reducing the waviness of the substrate surface and the embedded alumina following the rough polishing steps, the material of the base layer is preferably a polyethylene terephthalate (PET) film and a polyester film, and more preferably a polyethylene terephthalate (PET) film from which a resin film having a high degree of hardness can be obtained. Further, the material of the foamed layer may be polyurethane, polystyrene, polyester, polyvinyl chloride, natural rubber, artificial rubber or the like. The material of the foamed layer is preferably polyurethane elastomer from the viewpoint of controllability of the properties such as compressability in consideration of reducing the waviness of the substrate surface and the embedded alumina following the rough polishing steps, and from the viewpoint of improving the resistance to abrasion at the time of polishing.

Further, in terms of improving the polishing removal rate and reducing the waviness of the substrate surface, the polishing pads used in the steps (1) and (2) have an average pore size of preferably 10 to 100 μm, more preferably 20 to 80 μm, still more preferably 30 to 60 μm, and even more preferably 35 to 55 μm.

[Polishing Down Force in Step (1)]

The term “polishing down force” refers to a pressure applied to the polishing surface of the substrate to be polished during polishing by the platens. In terms of reducing the embedded alumina following the rough polishing steps, the polishing down force in the step (1) is preferably 30 kPa or less, more preferably 25 kPa or less, still more preferably 20 kPa or less, even more preferably 18 kPa or less, still even more preferably 16 kPa or less, still even more preferably 14 kPa or less, and still even more preferably 12 kPa or less. Further, in terms of reducing the waviness of the substrate surface and improving the polishing removal rate, the polishing down force is preferably 3 kPa or more, more preferably 5 kPa or more, still more preferably 7 kPa or more, even more preferably 8 kPa or more, and still even more preferably 9 kPa or more. Thus, all factors considered, the polishing down force is preferably 3 to 30 kPa, more preferably 5 to 25 kPa, still more preferably 7 to 20 kPa, even more preferably 8 to 18 kPa, still even more preferably 9 to 16 kPa, still even more preferably 9 to 14 kPa, and still even more preferably 9 to 12 kPa. The polishing down force can be adjusted by controlling the air pressure or weight imposed on the platens or the substrate.

[Amount of Polishing in Step (1)]

In terms of reducing plating defects, the waviness of the substrate surface, and the embedded alumina following the rough polishing steps, the amount of polishing per unit area (1 cm²) of the substrate to be polished is preferably 0.4 mg or more, more preferably 0.6 mg or more, and still more preferably 0.8 mg or more. On the other hand, in terms of improving the productivity and reducing the embedded alumina following the rough polishing steps, the amount of polishing is preferably 2.6 mg or less, more preferably 2.1 mg or less, and still more preferably 1.7 mg or less. Therefore, from the aforementioned viewpoints, the amount of polishing is preferably 0.4 to 2.6 mg, more preferably 0.6 to 2.1 mg, and still more preferably 0.8 to 1.7 mg.

[Supply Rate of Polishing Liquid Composition A]

In terms of reducing cost and the embedded alumina following the rough polishing steps, the supply rate of the polishing liquid composition A in the step (1) is preferably 0.25 mL/min or less, more preferably 0.2 mL/min or less, and still more preferably 0.15 mL/min or less per 1 cm² of the substrate to be polished. Further, in terms of improving the polishing removal rate and reducing the embedded alumina following the rough polishing steps, the supply rate is preferably 0.01 mL/min or more, more preferably 0.025 mL/min or more, and still more preferably 0.05 mL/min or more per 1 cm² of the substrate to be polished. Thus, all factors considered, the supply rate is preferably 0.01 to 0.25 mL/min, more preferably 0.025 to 0.2 mL/min, and still more preferably 0.05 to 0.15 mL/min per 1 cm² of the substrate to be polished.

[Method for Supplying Polishing Liquid Composition A to Polisher]

Examples of methods for supplying the polishing liquid composition A to the polisher include supplying the composition continuously with a pump, for example. When supplying the polishing liquid composition to the polisher, the polishing liquid composition may be supplied as a single liquid containing all of its components. In addition, the polishing liquid composition may be divided into a plurality of blending component liquids in view of, for example, the preservation stability of the polishing liquid composition, and supplied in the form of two or more liquids. In the latter case, the plurality of blending component liquids are mixed together, for example, in a feeding pipe or on the substrate to be polished, serving as the polishing liquid composition A.

[Polishing Down Force in Rinsing Step]

In terms of reducing the embedded alumina into the substrate following the rough polishing steps and reducing protrusion defects of the substrate following the final polishing step, the polishing down force in the rinsing step is preferably 25 kPa or less, more preferably 20 kPa or less, still more preferably 15 kPa or less, and even more preferably 14 kPa or less. Further, in terms of improving the polishing removal rate, the polishing down force is preferably 3 kPa or more, more preferably 5 kPa or more, still more preferably 7 kPa or more, and even more preferably 9 kPa or more. Thus, all factors considered, the polishing down force is preferably 3 to 25 kPa, more preferably 5 to 20 kPa, still more preferably 7 to 15 kPa, and even more preferably 9 to 14 kPa. It is considered that when the polishing down force is set within the aforementioned ranges alumina particles are prevented from sticking into the substrate, thereby effectively reducing the embedded alumina.

[Supply Rate of Rinse Liquid in Rinsing Step]

In terms of effectively reducing the embedded alumina in the substrate following the rough polishing steps and protrusion defects of the substrate following the final polishing step, and preventing alumina from being carried into the final polishing step, the supply rate of the rinse solution in the rinsing step is preferably 0.25 to 4 mL/min, more preferably 0.8 to 2.5 mL/min, and still more preferably 1 to 2 mL/min per 1 cm² of the substrate to be polished. Further, from the same viewpoints as noted above, the supply time of the rinse solution in the rinsing step is preferably 5 to 60 seconds, more preferably 7 to 30 seconds, and still more preferably 10 to 20 seconds. The method for supplying the rinse solution to the polisher in the rinsing step may be the same as the method for supplying the polishing liquid composition A to the polisher.

[Polishing Down Force in Step (2)]

In terms of reducing the embedded alumina following the rough polishing steps and protrusion defects following the final polishing step, the polishing down force in the step (2) is preferably 18 kPa or less, more preferably 15 kPa or less, still more preferably 13 kPa or less, and even more preferably 11 kPa or less. Further, in terms of improving the polishing removal rate, the polishing down force is preferably 3 kPa or more, more preferably 5 kPa or more, still more preferably 6 kPa or more, and even more preferably 7 kPa or more. Thus, all factors considered, the polishing down force is preferably 3 to 18 kPa, more preferably 5 to 15 kPa, still more preferably 6 to 13 kPa, and even more preferably 7 to 11 kPa. It is considered that when the polishing down force is set within the aforementioned ranges alumina particles are prevented from sticking into the substrate, thereby effectively reducing the embedded alumina.

[Amount of Polishing in Step (2)]

In terms of reducing the embedded alumina following the rough polishing steps, preventing alumina particles from being carried into the final polishing step, and reducing protrusion defects following the final polishing step, the amount of polishing per unit area (1 cm²) of the substrate to be polished is preferably 0.0004 mg or more, more preferably 0.004 mg or more, and still more preferably 0.01 mg or more. On the other hand, in terms of improving the productivity, the amount of polishing is preferably 0.85 mg or less, more preferably 0.43 mg or less, still more preferably 0.26 mg or less, and even more preferably 0.1 mg or less. Thus, all factors considered, the amount of polishing is preferably 0.0004 to 0.85 mg, more preferably 0.004 to 0.43 mg, still more preferably 0.01 to 0.26 mg, and even more preferably 0.01 to 0.1 mg.

[Supply Rate of Polishing Liquid Composition B]

The supply rate of the polishing liquid composition B in the step (2) may be the same as the polishing removal rate of the polishing liquid composition A discussed above.

[Method for Supplying Polishing Liquid Composition B to Polisher]

The method for supplying the polishing liquid composition B to the polisher is the same as the method for supplying the polishing liquid composition A to the polisher. In terms of improving the productivity, it is preferable to use in the step (2) the same polished as the one used in the step (1). It is preferable that the polishing liquid composition B is supplied using a different means from that used in supplying the polishing liquid composition A.

[Polishing Pad in Step (4)]

In the step (4), the same type of polishing pad as those used in the steps (1) and (2) may be used. In terms of reducing protrusion defects, scratches, and surface roughness following the final polishing step, the polishing pad used in the step (4) has an average pore size of preferably 1 to 50 μm, more preferably 2 to 40 μm, still more preferably 3 to 30 μm, and even more preferably 3 to 10 μm.

[Polishing Down Force in Step (4)]

In terms of reducing the embedded alumina following the rough polishing steps and protrusion defects following the final polishing step, the polishing down force in the step (4) is preferably 16 kPa or less, more preferably 14 kPa or less, still more preferably 13 kPa or less, and even more preferably 12 kPa or less. Further, in terms of reducing the waviness of the substrate surface and improving the polishing removal rate, the polishing down force is preferably 7.5 kPa or more, more preferably 8.5 kPa or more, and still more preferably 9.5 kPa or more. Thus, all factors considered, the polishing down force is preferably 7.5 to 16 kPa, more preferably 8.5 to 14 kPa, still more preferably 9.5 to 13 kPa, and even more preferably 9.5 to 12 kPa.

[Amount of Polishing in Step (4)]

In terms of reducing protrusion defects, scratches, and surface roughness following the final polishing step, the amount of polishing per unit area (1 cm²) of the substrate to be polished in the step (4) is preferably 0.085 mg or more, more preferably 0.13 mg or more, and still more preferably 0.17 mg or more. Further, in terms of improving the productivity, the amount of polishing is preferably 0.85 mg or less, more preferably 0.6 mg or less, and still more preferably 0.43 mg or less. Thus, all factors considered, the amount of polishing is preferably 0.085 to 0.85 mg, more preferably 0.13 to 0.6 mg, and still more preferably 0.17 to 0.43 mg.

[Supply Rate of Polishing Liquid Composition C]

The supply rate of the polishing liquid composition C in the step (4) may be the same as the polishing removal rate of the polishing liquid composition A discussed above.

[Method for Supplying Polishing Liquid Composition C to Polisher]

The method for supplying the polishing liquid composition C to the polisher may be the same as the method for supplying the polishing liquid composition A to the polisher.

[Polishing Liquid Composition A]

In terms of improving the polishing removal rate, the polishing liquid composition A used in the step (1) contains alumina particles.

[Alumina Particles]

Examples of the alumina particles include α-alumina, intermediate alumina, amorphous alumina, and fumed alumina. In terms of improving the polishing removal rate, α-alumina is preferred. Further, in terms of reducing the surface roughness, the waviness of the substrate surface, the embedded alumina following the rough polishing steps and protrusion defects of the substrate following the final polishing step, intermediate alumina is preferred.

In terms of reducing the surface roughness, the waviness of the substrate surface, and the embedded alumina following the rough polishing steps and improving the polishing removal rate, the alumina particles have an average secondary particle size of preferably 0.1 to 0.8 μm, more preferably 0.1 to 0.75 μm, still more preferably 0.1 to 0.7 μm, even more preferably 0.15 to 0.7 μm, still even more preferably 0.2 to 0.7 μm, still even more preferably 0.2 to 0.68 μm, still even more preferably 0.2 to 0.65 μm, still even more preferably 0.25 to 0.55 μm, and still even more preferably 0.25 to 0.40 μm. The average secondary particle size can be determined by a method described in Examples.

In terms of reducing the surface roughness and the waviness of the substrate surface, improving the polishing removal rate, and reducing the embedded alumina following the rough polishing steps, the alumina particle content of the polishing liquid composition A is preferably 0.01 to 30 wt %, more preferably 0.05 to 20 wt %, still more preferably 0.1 to 15 wt %, even more preferably 1 to 10 wt %, and still even more preferably 1 to 6 wt %. Further, in terms of reducing the waviness of the substrate surface and improving the polishing removal rate, the alumina particles account for preferably 5 wt % or more, more preferably 10 wt % or more, and still more preferably 15 wt % or more of all of the abrasives contained in the polishing liquid composition A.

[α-Alumina]

The term “α-alumina” as used herein is a generic term for crystalline alumina particles in which a structure unique to α-alumina can be found in the crystal by X-ray diffraction. The structure unique to α-alumina can be determined based on the presence or absence of a peak at 35.1 to 35.3° (104 phase), 43.2 to 43.4° (113 phase) and 57.4 to 57.6° (116 phase) in 2θ area of the X-ray diffraction spectrum. The peak unique to α-alumina herein refers to a peak in a 104 phase unless otherwise specified.

In terms of improving the polishing removal rate and reducing the embedded alumina following the rough polishing steps, the percentage of α-phase of the α-alumina is preferably 50 to 99%, more preferably 60 to 97%, and still more preferably 60 to 80%. Here, the percentage of α-phase refers to a relative area of α-alumina-specific peak, where the peak area of the 104 phase of WA-1000 (α-alumina in which the percentage of α-phase is 99.9%, produced by Showa Denko Co., Ltd.) derived from 2θ=35.1 to 35.3° is 99.9% by X-ray diffraction. Specifically, the percentage of α-phase can be determined by a method described in Example. It is possible to use more than one type of α-alumina in which the percentage of α-phase is within the aforementioned ranges.

In terms of reducing the embedded alumina following the rough polishing steps and protrusion defects following the final polishing step as well as improving the polishing removal rate, the α-alumina has an average secondary particle size of preferably 0.1 to 0.8 μm, more preferably 0.1 to 0.75 μm, still more preferably 0.15 to 0.7 μm, even more preferably 0.2 to 0.65 μm, still even more preferably 0.25 to 0.6 μm, still even more preferably 0.25 to 0.55 μm, and still even more preferably 0.25 to 0.4 μm. The average secondary particle size can be determined by a method described in Examples.

In terms of improving the polishing removal rate and reducing the embedded alumina following the rough polishing steps, the α-alumina content of the polishing liquid composition A is preferably 0.01 to 30 wt %, more preferably 0.05 to 20 wt %, still more preferably 0.1 to 15 wt %, even more preferably 0.5 to 10 wt %, still even more preferably 1 to 10 wt %, and still even more preferably 1.5 to 6 wt %.

[Intermediate Alumina]

In terms of improving the polishing removal rate and reducing the embedded alumina following the rough polishing steps, it is preferable that the polishing liquid composition A contains intermediate alumina. Intermediate alumina is a generic term for particles of crystalline alumina other than α-alumina. Specific examples of intermediate alumina include γ-alumina, δ-alumina, θ-alumina, η-alumina, κ-alumina, and a mixture thereof. In particular, γ-alumina, δ-alumina, θ-alumina, and a mixture thereof are preferred, γ-alumina and θ-alumina are more preferred, and θ-alumina is still more preferred in terms of improving the polishing removal rate and reducing the embedded alumina following the rough polishing steps.

In terms of improving the polishing removal rate and reducing the embedded alumina following the rough polishing steps and protrusion defects following the final polishing step, intermediate alumina has an average secondary particle size of preferably 0.01 to 0.6 μm, more preferably 0.05 to 0.5 μm, still more preferably 0.1 to 0.4 μm, and even more preferably 0.15 to 0.35 μm. The average secondary particle size can be determined by the same method as that of α-alumina.

Further, in terms of reducing the embedded alumina following the rough polishing steps and protrusion defects following the final polishing step and improving the polishing removal rate, the intermediate alumina content of the polishing liquid composition A is preferably 0.001 to 27 wt %, more preferably 0.01 to 15 wt %, still more preferably 0.1 to 10 wt %, even more preferably 0.1 to 5 wt %, and still even more preferably 0.1 to 3 wt %.

In terms of improving the polishing removal rate and reducing the embedded alumina following the rough polishing steps, the alumina particles contained in the polishing liquid composition A are preferably of α-alumina and intermediate alumina, and more preferably of α-alumina and θ-alumina.

When using α-alumina and intermediate alumina, the weight ratio between α-alumina and intermediate alumina (wt % of α-alumina/wt % of intermediate alumina) is preferably 90/10 to 10/90, more preferably 85/15 to 40/60, still more preferably 85/15 to 50/50, even more preferably 85/15 to 60/40, still even more preferably 85/15 to 70/30, and still even more preferably 80/20 to 75/25 in terms of improving the polishing removal rate and reducing the waviness of the substrate surface and the embedded alumina following the rough polishing steps.

[Silica Particles]

In terms of reducing the embedded alumina following the rough polishing steps, it is preferable that the polishing liquid composition A further contains silica particles. Examples of silica particles include colloidal silica, fumed silica, and surface-modified silica particles. In particular, colloidal silica is preferred in terms of reducing the embedded alumina following the rough polishing steps.

In terms of reducing the embedded alumina following the rough polishing steps and improving the polishing removal rate, the silica particles have an average primary particle size (D50) of preferably 5 to 150 nm, more preferably 10 to 130 nm, still more preferably 20 to 120 nm, even more preferably 20 to 100 nm, still even more preferably 20 to 60 nm, and still even more preferably 20 to 50 nm. The average primary particle size can be determined by a method described in Examples.

Further, in terms of reducing the embedded alumina following the rough polishing steps and improving the polishing removal rate, the primary particle size standard deviation of the silica particles is preferably 8 to 55 nm, more preferably 10 to 50 nm, and still more preferably 15 to 45 nm. The standard deviation can be determined by a method described in Examples.

In terms of reducing the embedded alumina following the rough polishing steps and improving the polishing removal rate, the silica particles have a primary particle size (D10) of preferably 1 to 130 nm, more preferably 5 to 120 nm, still more preferably 10 to 110 nm, even more preferably 20 to 90 nm, still even more preferably 20 to 50 nm, and still even more preferably 20 to 30 nm. The primary particle size (D10) can be determined by a method described in Examples.

In terms of reducing the embedded alumina following the rough polishing steps and improving the polishing removal rate, the silica particles have a primary particle size (D90) of preferably 10 to 160 nm, more preferably 15 to 140 nm, still more preferably 20 to 130 nm, even more preferably 20 to 110 nm, and still even more preferably 20 to 80 nm. The primary particle size (D90) can be determined by a method described in Examples.

When using the alumina and silica particles, the weight ratio between the alumina and silica particles (weight of alumina particles/weight of silica particles) is preferably 10/90 to 80/20, more preferably 15/85 to 75/25, still more preferably 20/80 to 65/35, and even more preferably 20/80 to 60/40 in terms of reducing the embedded alumina following the rough polishing steps and improving the polishing removal rate.

When using the alumina and silica particles in combination, the ratio between the average secondary particle size (D50) of the alumina particles and the average primary particle size (D50) of the silica particles (average secondary particle size of alumina/average primary particle size of silica) is preferably 1 to 100, more preferably 2 to 50, still more preferably 4 to 40, and even more preferably 5 to 30 in terms of reducing the embedded alumina following the rough polishing steps and improving the polishing removal rate.

In terms of reducing the embedded alumina following the rough polishing steps and improving the polishing removal rate, the silica particle content of the polishing liquid composition A is preferably 0.1 wt % or more, more preferably 0.5 wt % or more, still more preferably 1 wt % or more, even more preferably 1.5 wt % or more, and still even more preferably 2 wt % or more. Further, in terms of an economic viewpoint, the silica particle content is preferably 30 wt % or less, more preferably 25 wt % or less, still more preferably 20 wt % or less, even more preferably 15 wt % or less, and still even more preferably 10 wt % or less. Thus, all factors considered, the silica particle content is preferably 0.1 to 30 wt %, more preferably 0.5 to 25 wt %, still more preferably 1 to 20 wt %, even more preferably 1.5 to 15 wt %, still even more preferably 2 to 15 wt %, and still even more preferably 2 to 10 wt %.

[Diallylamine Polymer]

In terms of reducing the embedded alumina following the rough polishing steps and protrusion defects following the final polishing step, it is preferable that the polishing liquid composition A contains a diallylamine polymer. It is considered that the diallylamine polymer is positively charged in the polishing liquid so that it adheres to the substrate surface and forms a protective coat thereon, thereby preventing the embedded alumina and the adherence of alumina. The term “diallylamine polymer” as used herein refers to a polymer having constitutional units in which amine compounds having two allyl groups, such as diallylamines, are introduced as monomers. Further, the diallylamine polymer used in the present invention is water soluble. Here, being “water soluble” means that the diallylamine polymer has solubility of 2 g or more in 100 g of water at 20° C.

In terms of reducing the embedded alumina following the rough polishing steps and protrusion defects following the final polishing step, it is preferable that the diallylamine polymer has one or more constitutional units selected from the constitutional units represented by the following general formulas (I-a), (I-b), (I-c), and (I-d).

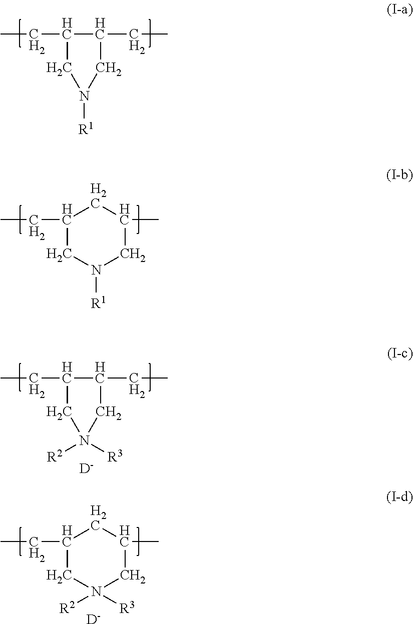

R¹ in the general formulae (I-a) and (I-b) is a hydrogen atom or a C₁₋₁₀ alkyl group or C₇₋₁₀ aralkyl group that may have a hydroxyl group. Here, a C₁₋₁₀ alkyl group that may have a hydroxyl group may be either linear, branched, or cyclic. In terms of reducing the embedded alumina following the rough polishing steps and protrusion defects of the substrate following the final polishing step, R¹ is preferably a C₁₋₄ alkyl group that may have a hydroxyl group, more preferably a methyl group, ethyl group, n-propyl group, isopropyl group, any of various butyl groups, 2-hydroxyethyl group, 2-hydroxypropyl group, or 3-hydroxypropyl group, and more preferably a methyl group or ethyl group. Further, in terms of reducing the embedded alumina following the rough polishing steps and protrusion defects following the final polishing step, preferred examples of C₇₋₁₀ aralkyl groups include a benzyl group and a phenethyl group. In particular, R¹ is preferably a hydrogen atom, methyl group, ethyl group or benzyl group, and more preferably a methyl group or ethyl group in terms of reducing the embedded alumina following the rough polishing steps and protrusion defects following the final polishing step. When the diallylamine polymer includes the constitutional units represented by the general formulae (I-a) and (I-b), R¹ may be the same or may not be the same.

The constitutional units represented by the general formulae (I-a) and (I-b) may be in the form of acid addition salts. Examples of acid addition salts include hydrochlorides, hydrobromates, acetates, sulfates, nitrates, sulfites, phosphates, amidosulfates, and methansulfonates. In particular, hydrochlorides, hydrobromates and acetates are preferred.

R² in the general formulae (I-c) and (I-d) is a C₁₋₁₀ alkyl group or C₇₋₁₀ aralkyl group that may have a hydroxyl group. Preferred forms of C₁₋₁₀ alkyl group or C₇₋₁₀ aralkyl group that may have a hydroxyl group are as explained above in connection with R¹.

Further, in the general formulae (I-c) and (I-d), R³ is a C₁₋₄ alkyl group or C₇₋₁₀ aralkyl group, and D⁻ is a monovalent anion.

The C₁₋₄ alkyl group may be either linear or branched, and examples of such an alkyl group include a methyl group, an ethyl group, a propyl group, an isopropyl group and various butyl groups. In particular, a methyl group and an ethyl group are preferred in terms of reducing the embedded alumina following the rough polishing steps and protrusion defects following the final polishing step. In terms of reducing the embedded alumina following the rough polishing steps and protrusion defects following the final polishing step, preferred examples of the C₇₋₁₀ aralkyl group include a benzyl group and a phenethyl group. Examples of the monovalent anion represented by D⁻ include halogen ion, methyl sulfate ion and ethyl sulfate ion.

Specific examples of a partial structure represented by >N⁺R²R³.D⁻ (a partial structure of the quaternary ammonium salt constitutional unit) in the general formulae (I-c) and (I-d) include N,N-dimethylammonium chloride, N,N-diethylammonium chloride, N,N-dipropylammonium chloride, N,N-dibutylammonium chloride, N-methyl-N-benzylammonium chloride, N-ethyl-N-benzylammonium chloride, and bromides, iodides, and methyl sulfates corresponding to these chlorides. In particular, N,N-dimethylammonium chloride and N-methyl-N-benzylammonium chloride are preferred, and N,N-dimethylammonium chloride is more preferred in terms of reducing the embedded alumina following the rough polishing steps and protrusion defects following the final polishing step.

Among the constitutional units represented by the general formulae (I-a), (I-c), and (I-d), the diallylamine polymer preferably includes one or more selected from the constitutional units represented by the general formulae (I-c) and (I-d), and more preferably the constitutional unit represented by the general formula (I-c) in terms of reducing the embedded alumina following the rough polishing steps and protrusion defects following the final polishing step.

In terms of reducing the embedded alumina following the rough polishing steps and protrusion defects following the final polishing step and improving the polishing removal rate, the constitutional units represented by the general formulae (I-b), (I-c), and (I-d) together account for preferably 30 to 100 mol %, more preferably 35 to 90 mol %, still more preferably 40 to 80 mol %, and even more preferably 40 to 60 mol % of all of the constitutional units of the diallylamine polymer.

In terms of reducing the embedded alumina following the rough polishing steps and protrusion defects following the final polishing step, it is preferable that the diallylamine polymer further includes a constitutional unit represented by the following general formula (II).

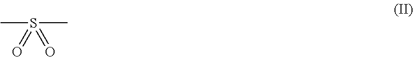

In terms of reducing the embedded alumina following the rough polishing steps and protrusion defects following the final polishing step and improving the polishing removal rate, the constitutional unit represented by the general formula (II) accounts for preferably 10 to 60 mol %, more preferably 20 to 60 mol %, still more preferably 30 to 60 mol %, and even more preferably 40 to 60 mol % of all of the constitutional units of the diallylamine polymer.

Of all of the constitutional units of the diallylamine polymer, the molar ratio between the constitutional units represented by the general formulae (I-a) to (I-d) and the constitutional unit represented by the general formula (II) (general formulae (I-a) to (I-d)/general formula (II)) is preferably 100/0 to 30/70, more preferably 90/10 to 30/70, still more preferably 80/20 to 40/60, even more preferably 70/30 to 40/60, and still even more preferably 60/40 to 40/60 in terms of reducing the embedded alumina following the rough polishing steps and protrusion defects following the final polishing step and improving the polishing removal rate.

In terms of reducing the embedded alumina following the rough polishing steps and protrusion defects following the final polishing step, the constitutional units represented by the general formulae (I-a) to (I-d) and (II) together account for preferably 50 mol % or more, more preferably 60 mol % or more, still more preferably 70 mol % or more, even more preferably 80 mol % or more, still even more preferably 90 mol % or more, still even more preferably 95 mol % or more, still even more preferably 97 mol % or more, and still even more preferably 100 mol % of all of the constitutional units of the diallylamine polymer.

The diallylamine polymer may include constitutional units other than those represented by the general formulae (I-a) to (I-d) and (II). Examples of such additional constitutional units include those derived from ethylenically unsaturated sulfonic acid compounds, ethylenically unsaturated carboxylic acid compounds, and acrylamide compounds.

Examples of the ethlenically unsaturated sulfonic acid compounds include styrenesulfonic acid, α-methylstyrenesulfonic acid, vinyltoluenesulfonic acid, vinylnaphthalenesulfonic acid, vinylbenzylsulfonic acid, 2-acrylamide-2-methylpropanesulfonic acid, acryloyloxyethylsulfonic acid, and methacryloyloxypropylsulfonic acid. These sulfonic acids may also be used in the form of alkali metal salts and ammonium salts. Examples of alkali metal salts include lithium salt, sodium salt and potassium salt. In particular, styrenesulfonic acid, 2-acrylamide-2-methylpropanesulfonic acid and sodium salts thereof are preferred in terms of reducing the embedded alumina following the rough polishing steps and protrusion defects following the final polishing step and improving the polishing removal rate.

Examples of the ethylenically unsaturated carboxylic acid compounds include 2-propenoic acid, 3-butenoic acid, 3-butanedioic acid, 4-pentenoic acid, 5-hexenoic acid, 6-heptene acid, 7-octene acid, 8-nonene acid, 9-decene acid, 10-undecene acid, and 11-dodecene acid and salts thereof. These carboxylic acids may also be used in the form of alkali metal salts and ammonium salts. Examples of alkali metal salts include lithium salt, sodium salt and potassium salt. In particular, 2-propenoic acid, 3-butenoic acid, 3-butanedioic acid, 4-pentenoic acid, 5-hexenoic acid, and salts thereof are preferred in terms of reducing the embedded alumina following the rough polishing steps and protrusion defects following the final polishing step and improving the polishing removal rate.

Examples of the acrylamide compounds include acrylamide, N-methylacrylamide, N-(hydroxymethyl)acrylamide, N,N-dimethylacrylamide, N-ethylacrylamide, N,N-diethylacrylamide, and N-(isopropyl)acrylamide. In particular, acrylamide and N-methylacrylamide are preferred in terms of reducing the embedded alumina following the rough polishing steps and improving the polishing removal rate.

In terms of reducing the embedded alumina following the rough polishing steps and protrusion defects following the final polishing step and improving the polishing removal rate, constitutional units other than those represented by the general formulae (I-a) to (I-d) and (II) account for preferably 0 to 30 mol %, more preferably 0 to 20 mol %, still more preferably 0 to 10 mol %, and even more preferably 0 to 5 mol % of all of the constitutional units of the diallylamine polymer. It is still even more preferable that the diallylamine polymer is substantially free of constitutional units other than those represented by the general formulas (I-a) to (I-d) and (II).

[Method for Producing Diallylamine Polymer]

The water-soluble diallylamine polymer can be produced by polymerizing, in a polar solvent in the presence of a radical initiator, acid addition salts and/or quaternary ammonium salts of diallylamines, and if needed sulfur dioxide and compounds for introducing other constitutional units.

Examples of the polar solvent include water, inorganic acids (such as hydrochloric acid, sulfuric acid, phosphoric acid, and polyphosphoric acid) and aqueous solutions thereof, aqueous solutions of metal salts of inorganic acids (such as zinc chloride, calcium chloride, and magnesium chloride), organic acids (such as formic acid, acetic acid, proprionic acid, and lactic acid) and aqueous solutions thereof, and polar organic solvents (such as alcohol, dimethylsulfoxide, and dimethylformamide). A mixture of these examples may also be used. In particular, aqueous solvents are preferred.

As the radical initiator, a water-soluble radical initiator having an azo group in the molecule and a persulfate-based radical initiator can be used preferably. A persulfate-based radical initiator is more preferred.

Examples of the acid additional salts of diallylamines include hydrochlorides, hydrobromates, sulfates, nitrates, sulfites, phosphates, amidesulfates and methansulfonates, such as diallylamine, N-methyldiallylamine, N-ethyldiallylamine, N-propyldiallylamine, N-butyldiallylamine, N-2-hydroxyethyldiallylamine, N-2-hydroxypropyldiallylamine, and N-3-hydroxypropyldiallylamine. Examples of the quaternary ammonium salts of diallylamines include diallyl dimethyl ammonium chloride, diallyl dimethyl ammonium bromide, diallyl dimethyl ammonium iodide, diallyl dimethyl ammonium methyl sulfate, diallyl dimethyl ammonium ethyl sulfate, diallyl diethyl ammonium chloride, diallyl diethyl ammonium bromide, diallyl diethyl ammonium iodide, diallyl diethyl ammonium methyl sulfate, diallyl diethyl ammonium ethyl sulfate, diallyl methyl-benzyl ammonium chloride, diallyl methyl-benzyl ammonium bromide, diallyl methyl-benzyl ammonium iodide, diallyl methyl-benzyl ammonium methyl sulfate, diallyl methyl-benzyl ammonium ethyl sulfate, diallyl ethyl-benzyl ammonium chloride, diallyl ethyl-benzyl ammonium bromide, diallyl ethyl-benzyl ammonium iodide, diallyl ethyl-benzyl ammonium methyl sulfate, and diallyl ethyl-benzyl ammonium ethyl sulfate. In particular, diallylamine, diallyl dimethyl ammonium chloride, diallyl dimethyl ammonium methyl sulfate, diallyl diethyl ammonium chloride, and diallyl methyl-benzyl ammonium chloride are preferred, and diallyl dimethyl ammonium chloride is more preferred in terms of reducing the embedded alumina following the rough polishing steps and protrusion defects following the final polishing step and improving the polishing removal rate.

In terms of improving the polishing removal rate and reducing the embedded alumina following the rough polishing steps and protrusion defects following the final polishing step, the diallylamine polymer has a weight-average molecular weight of preferably 1,000 or more, more preferably 1,500 or more, still more preferably 2,000 or more, and even more preferably 4,000 or more, and preferably 200,000 or less, more preferably 150,000 or less, still more preferably 100,000 or less, even more preferably 50,000 or less, still even more preferably 20,000 or less, and still even more preferably 15,000 or less. Therefore, in terms of improving the polishing removal rate and reducing the embedded alumina following the rough polishing steps and protrusion defects following the final polishing step, the diallylamine polymer has a weight-average molecular weight of preferably 1,000 to 200,000, more preferably 1,000 to 150,000, still more preferably 1,000 to 100,000, even more preferably 1,500 to 50,000, still even more preferably 2,000 to 20,000, and still even more preferably 4,000 to 15,000. The weight-average molecular weight can be determined by a method described in Examples.

In terms of improving the polishing removal rate and reducing the embedded alumina following the rough polishing steps and protrusion defects following the final polishing step, the diallylamine polymer content of the polishing liquid composition A is preferably 0.001 wt % or more, more preferably 0.005 wt % or more, and still more preferably 0.01 wt % or more, and preferably 1.0 wt % or less, more preferably 0.5 wt % or less, still more preferably 0.3 wt % or less, even more preferably 0.1 wt % or less, and still even more preferably 0.05 wt % or less. Therefore, in terms of improving the polishing removal rate and reducing the embedded alumina following the rough polishing steps and protrusion defects following the final polishing step, the diallylamine polymer content of the polishing liquid composition A is preferably 0.001 to 1.0 wt %, more preferably 0.005 to 0.5 wt %, still more preferably 0.01 to 0.3 wt %, even more preferably 0.01 to 0.1 wt %, and still even more preferably 0.01 to 0.05 wt %.

In terms of reducing the embedded alumina following the rough polishing steps and protrusion defects following the final polishing step and improving the polishing removal rate, the ratio between the diallylamine polymer content and the alumina particle content of the polishing liquid composition A (diallylamine polymer content/alumina content) is preferably 0.001 to 0.1, more preferably 0.002 to 0.05, and still more preferably 0.002 to 0.02.

[Acid]

In terms of improving the polishing removal rate and reducing the embedded alumina following the rough polishing steps and protrusion defects following the final polishing step, it is preferable that the polishing liquid composition A contains an acid. The use of acids in the polishing liquid composition A includes use of acids and/or salts thereof. Examples of useable acids include: inorganic acids such as nitric acid, sulfuric acid, sulfurous acid, persulfuric acid, hydrochloric acid, perchloric acid, phosphoric acid, phosphonic acid, phosphinic acid, pyrophosphoric acid, tripolyphosphoric acid, and amidosulfuric acid; organic phosphonic acids such as 2-aminoethylphosphonic acid, 1-hydroxyethylidene-1,1-diphosphonic acid, aminotri(methylenephosphonic acid), ethylenediaminetetra(methylenephosphonic acid), diethylenetriaminepenta(methylenephosphonic acid), ethane-1,1-diphosphonic acid, ethane-1,1,2-triphosphonic acid, ethane-1-hydroxy-1,1-diphosphonic acid, ethane-1-hydroxy-1,1,2-triphosphonic acid, ethane-1,2-dicarboxy-1,2-diphosphonic acid, methanehydroxyphosphonic acid, 2-phosphonobutane-1,2-dicarboxylic acid, 1-phosphonobutane-2,3,4-tricarboxylic acid, and α-methyl phosphonosuccinic acid; aminocarboxylic acids such as glutamic acid, picolinic acid, and aspartic acid; and carboxylic acids such as citric acid, tartaric acid, oxalic acid, nitroacetic acid, maleic acid, and oxalacetic acid. In particular, phosphoric acid, sulfuric acid, citric acid, tartaric acid, maleic acid, 1-hydroxyethylidene-1,1-diphosphonic acid, aminotri(methylenephosphonic acid), ethylenediaminetetra(methylenephosphonic acid), diethylenetriaminepenta(methylenephosphonic acid) and salts thereof are more preferred in terms of reducing the embedded alumina following the rough polishing step and the waviness of the substrate surface and improving the polishing removal rate.

These acids and salts thereof may be used alone or in combination of two or more. However, in terms of improving the polishing removal rate and reducing the embedded alumina following the rough polishing steps and protrusion defects following the final polishing step, it is preferable to use the acids and salts thereof in combination of two or more, and it is more preferable to use two or more acids selected from the group consisting of phosphoric acid, sulfuric acid, citric acid, tartaric acid, and 1-hydroxyethylidene-1,1-diphosphonic acid in combination.

Salts of these acids are not particularly limited in use, and specific examples of salts include metal salts, ammonium salts, and alkylammonium salts. Specific examples of the metals include those belonging to Groups 1A, 1B, 2A, 2B, 3A, 3B, 4A, 6A, 7A and 8 in the periodic table (long period form). In particular, salts of metals belonging to Group 1A or ammonium salts are preferred in terms of improving the polishing removal rate and reducing the embedded alumina following the rough polishing steps and protrusion defects following the final polishing step.

In terms of improving the polishing removal rate and reducing the embedded alumina following the rough polishing steps and protrusion defects following the final polishing step, the acid content of the polishing liquid composition A is preferably 0.001 to 5 wt %, more preferably 0.01 to 4 wt %, still more preferably 0.05 to 3 wt %, even more preferably 0.1 to 2 wt %, and still even more preferably 0.1 to 1 wt %.

[Oxidizing Agent]

In terms of improving the polishing removal rate and reducing the embedded alumina following the rough polishing steps and protrusion defects following the final polishing step, it is preferable that the polishing liquid composition A contains an oxidizing agent. Examples of the oxidizing agent include peroxides, permanganic acid or salts thereof, chromic acid or salts thereof, peroxo acid or salts thereof, oxo acid or salts thereof, and metal salts. In particular, hydrogen peroxide, iron(III) nitrate, peracetic acid, ammonium peroxodisulfate, iron(III) sulfate and ammonium iron(III) sulfate are preferred, and hydrogen peroxide is more preferred in terms of improving the polishing removal rate, its general purpose usability and inexpensiveness and the fact that metal ions do not attach to its surface. These oxidizing agents may be used alone or in combination of two or more.

In terms of improving the polishing removal rate and reducing the embedded alumina following the rough polishing steps and protrusion defects following the final polishing step, the oxidizing agent content of the polishing liquid composition A is preferably 0.01 wt % or more, more preferably 0.05 wt % or more, and still more preferably 0.1 w % or more. Further, in terms of improving the polishing removal rate and reducing the embedded alumina following the rough polishing steps and protrusion defects following the final polishing step, the oxidizing agent content is preferably 4 wt % or less, more preferably 2 wt % or less, still more preferably 1.5 wt % or less, and even more preferably 1 wt % or less. Therefore, in order to improve the polishing removal rate while maintaining the surface quality, the oxidizing agent content is preferably 0.01 to 4 wt %, more preferably 0.05 to 2 wt %, still more preferably 0.1 to 1.5 wt %, and even more preferably 0.1 to 1 wt %.

[Water]

The polishing liquid composition A contains water as a medium. For example, distilled water, ion exchanged water, pure water, and ultrapure water can be used. The water content of the polishing liquid composition A is preferably 55 to 99 wt %, more preferably 70 to 98 wt %, still more preferably 80 to 97 wt %, and even more preferably 85 to 97 wt % because the polishing liquid composition can be handled with ease.

[Other Components]

Other components can also be included in the polishing liquid composition A as needed. Examples of other components include thickeners, dispersants, rust-preventive agents, basic materials, surfactants, and high molecular compounds. The voluntary component content of the polishing liquid composition A is preferably within a range that does not impair the effects of the present invention, and the voluntary component content is preferably 0 to 10 wt %, and more preferably 0 to 5 wt %.

[pH of Polishing Liquid Composition A]

In terms of improving the polishing removal rate and reducing the embedded alumina following the rough polishing steps and protrusion defects following the final polishing step, the pH of the polishing liquid composition A is adjusted, with the use of any of the aforementioned acids or known pH adjusters, to preferably 1 to 6, more preferably 1 to 4, still more preferably 1 to 3, and even more preferably 1 to 2. The pH of the polishing liquid composition is at 25° C., and can be measured using a PH meter. The value is one obtained after 40 minutes from the immersion of an electrode of the pH meter.

[Method for Preparing Polishing Liquid Composition A]

The polishing liquid composition A can be prepared by, for example, mixing alumina particles and water, and if desired, silica particles, the diallylamine polymer, an oxidizing agent, acid, and other components by a known method. When mixing silica particles, the silica particles may be mixed in the form of concentrated slurry or may be mixed after being diluted with water or the like. As another aspect, the polishing liquid composition A may be prepared in the form of a concentrate. The mixing is not particularly limited, and can be carried out using an agitator such as a homo-mixer, a homogenizer, an ultrasonic disperser, and a wet ball mill.

[Polishing Liquid Composition B]

In terms of reducing the embedded alumina following the rough polishing steps and protrusion defects following the final polishing step, the polishing liquid composition B used in the step (2) contains silica particles. The silica particles to be used are similar to those used in the polishing liquid composition A, and are preferably of colloidal silica.

In terms of reducing the embedded alumina following the rough polishing steps and protrusion defects following the final polishing step, the silica particles used in the polishing liquid composition B have an average primary particle size (D50) of 5 nm or more, preferably 7 nm or more, more preferably 10 nm or more, and still more preferably 15 nm or more, and 60 nm or less, preferably 55 nm or less, more preferably 50 nm or less, still more preferably 45 nm or less, even more preferably 40 nm or less, and still even more preferably 30 nm or less. Therefore, in terms of reducing the embedded alumina following the rough polishing steps and protrusion defects following the final polishing step, the silica particles used in the polishing liquid composition B have an average primary particle size (D50) of 5 to 60 nm, preferably 7 to 55 nm, more preferably 10 to 50 nm, still more preferably 15 to 45 nm, even more preferably 15 to 40 nm, and still even more preferably 15 to 30 nm. It is considered that when the average primary particle size (D50) of the silica particles is within the aforementioned ranges, a fractional force increases during polishing/cutting, thereby effectively reducing the embedded alumina. The average primary particle size can be determined by a method described in Examples.

Further, in terms of reducing the embedded alumina following the rough polishing steps and protrusion defects following the final polishing step, the primary particle size standard deviation of the silica particles used in the polishing liquid composition B is less than 40 nm, preferably 39 nm or less, more preferably 35 nm or less, still more preferably 30 nm or less, and even more preferably 20 nm or less. Further, from the same viewpoints, the primary particle size standard deviation is preferably 5 nm or more, more preferably 7 nm or more, still more preferably 10 nm or more, and even more preferably 15 nm or more. Therefore, in terms of reducing the embedded alumina following the rough polishing steps and protrusion defects following the final polishing step, the primary particle size standard deviation of the silica particles used in the polishing liquid composition B is less than 40 nm, preferably 5 nm or more and less than 40 nm, more preferably 5 to 39 nm, still more preferably 7 to 35 nm, even more preferably 10 to 30 nm, and still even more preferably 15 to 20 nm. It is considered that when the primary particle size standard deviation is within the aforementioned ranges a fractional force further increases during polishing/cutting and alumina particles embedded during the step (1) are pulled out effectively, thereby reducing the embedded alumina. The standard deviation can be determined by a method described in Examples.

In terms of reducing the embedded alumina following the rough polishing steps and protrusion defects following the final polishing step, the silica particles used in the polishing liquid composition B have a primary particle size (D10) of preferably 1 nm or more, more preferably 3 nm or more, still more preferably 5 nm or more, even more preferably 10 nm or more, and still even more preferably 15 nm or more. Further, from the same viewpoints, the primary particle size (D10) is preferably 50 nm or less, more preferably 40 nm or less, still more preferably 35 nm or less, even more preferably 30 nm or more, and still even more preferably 25 nm or less. Therefore, in terms of reducing the embedded alumina following the rough polishing steps and protrusion defects following the final polishing step, the silica particles used in the polishing liquid composition B have a primary particle size (D10) of preferably 1 to 50 nm, more preferably 3 to 40 nm, still more preferably 5 to 35 nm, even more preferably 10 to 30 nm, and still even more preferably 15 to 25 nm. The primary particle size (D10) can be determined by a method described in Examples.

In terms of reducing the embedded alumina following the rough polishing steps and protrusion defects following the final polishing step, the silica particles used in the polishing liquid composition B have a primary particle size (D90) of preferably 8 nm or more, more preferably 10 nm or more, still more preferably 15 nm or more, and even more preferably 20 nm or more, and preferably 80 nm or less, more preferably 70 nm or less, still more preferably 60 nm or less, even more preferably 55 nm or less, still even more preferably 50 nm or less, and still even more preferably 30 nm or less. The primary particle size (D90) can be determined by a method described in Examples. Therefore, in terms of reducing the embedded alumina following the rough polishing steps and protrusion defects following the final polishing step, the silica particles used in the polishing liquid composition B have a primary particle size (D90) of preferably 8 to 80 nm, more preferably 10 to 70 nm, still more preferably 15 to 60 nm, even more preferably 15 to 55 nm, still even more preferably 20 to 50 nm, and still even more preferably 20 to 30 nm. The primary particle size (D90) can be determined by a method described in Examples.

In terms of reducing the embedded alumina following the rough polishing steps and protrusion defects following the final polishing step, the silica particle content of the polishing liquid composition B is preferably 0.1 wt % or more, more preferably 0.5 wt % or more, still more preferably 1 wt % or more, and even more preferably 2 wt % or more. Further, from an economic viewpoint, the silica particle content is preferably 30 wt % or less, more preferably 25 wt % or less, still more preferably 20 wt % or less, even more preferably 15 wt % or less, and still even more preferably 10 wt % or less. Thus, all factors considered, the silica particle content is preferably 0.1 to 30 wt %, more preferably 0.5 to 25 wt %, still more preferably 1 to 20 wt %, even more preferably 2 to 15 wt %, and still even more preferably 2 to 10 wt %.

Further, in terms of reducing the embedded alumina following the rough polishing steps and protrusion defects following the final polishing step, the silica particles account for preferably 60 wt % or more, more preferably 80 wt % or more, still more preferably 90 wt % or more, and even more preferably 100 wt % of all of the abrasives contained in the polishing liquid composition B. In terms of reducing the embedded alumina following the rough polishing steps and protrusion defects following the final polishing step, the alumina particles account for preferably 40 wt % or less, more preferably 20 wt % or less, still more preferably 10 wt % or less, and even more preferably 5 wt % or less of all of the abrasives contained in the polishing liquid composition B. Still even more preferably, the polishing liquid composition B is substantially free of alumina particle.

[Heterocyclic Aromatic Compound]

In terms of reducing the embedded alumina following the rough polishing steps and protrusion defects following the final polishing step, it is preferable that the polishing liquid composition B contains a heterocyclic aromatic compound. It is considered that since a heterocyclic aromatic compound carries positive electric charge, it adheres onto the substrate surface and forms a protective coat thereon, thereby preventing alumina from reattaching to the substrate surface. Examples of preferred heterocyclic aromatic compounds include pyrimidine, pyrazine, pyridazine, pyridine, 1,2,3-triazine, 1,2,4-triazine, 1,2,5-triazine, 1,3,5-triazine, 1,2,4-oxadiazole, 1,2,5-oxadiazole, 1,3,4-oxadiazole, 1,2,5-thiadiazole, 1,3,4-thiadiazole, 3-aminopyrazole, 4-aminopyrazole, 3,5-dimethylpyrazole, pyrazole, 2-aminoimidazole, 4-aminoimidazole, 5-aminoimidazole, 2-methylimidazole, 2-ethylimidazole, imidazole, benzoimidazole, 1,2,3-triazole, 4-amino-1,2,3-triazole, 5-amino-1,2,3-triazole, 1,2,4-triazole, 3-amino-1,2,4-triazole, 5-amino-1,2,4-triazole, 3-mercapto-1,2,4-triazole, 1H-tetrazole, 5-aminotetrazole, 1H-benzotriazole, 1H-tolyltriazole, 2-aminobenzotriazole, 3-aminobenzotriazole, and alkyl-substituted or amine-substituted products thereof. An exemplary alkyl group of the aforementioned alkyl-substituted products includes a C₁₋₄ lower alkyl group, more specifically a methyl group or ethyl group. Further, examples of the amine-substituted products include 1-[N,N-bis(hydroxyethylene)aminomethyl]benzotriazole and 1-[N,N-bis(hydroxyethylene)aminomethyl]tolyltriazole. In particular, 1H-tetrazole, 1H-benzotriazole, 1H-tolyltriazole, and pyrazole are preferred, 1H-tetrazole, 1H-benzotriazole, and pyrazole are more preferred, and 1H-benzotriazole and pyrazole are even more preferred in terms of their availability and reducing the embedded alumina following the rough polishing steps and protrusion defects following the final polishing step. These heterocyclic aromatic compounds may be used alone or in combination of two or more.

In terms of reducing the embedded alumina following the rough polishing steps and protrusion defects following the final polishing step, the heterocyclic aromatic compound content of the polishing liquid composition B is preferably 0.001 wt % or more, more preferably 0.005 wt % or more, still more preferably 0.01 wt % or more, and even more preferably 0.1 wt % or more and preferably 8 wt % or less, more preferably 5 wt % or less, still more preferably 3 wt % or less, even more preferably 2 wt % or less, and still even more preferably 1 wt % or less. Therefore, in terms of reducing the embedded alumina following the rough polishing steps and protrusion defects following the final polishing step, the heterocyclic aromatic compound content of the polishing liquid composition B is preferably 0.001 to 8 wt %, more preferably 0.001 to 5 wt %, still more preferably 0.005 to 5 wt %, even more preferably 0.01 to 5 wt %, still even more preferably 0.01 to 3 wt %, still even more preferably 0.1 to 3 wt %, still even more preferably 0.1 to 2 wt %, and still even more preferably 0.1 to 1 wt %.

Further, in terms of reducing the embedded alumina following the rough polishing steps and protrusion defects following the final polishing step, the ratio between the silica particle content and the heterocyclic aromatic compound content of the polishing liquid composition B [silica particle content (wt %)/heterocyclic aromatic compound content (wt %)] is preferably 0.01 or more, more preferably 0.5 or more, still more preferably 1 or more, even more preferably 2 or more, and still even more preferably 3 or more, and preferably 3,000 or less, more preferably 1,000 or less, still more preferably 750 or less, even more preferably 500 or less, still even more preferably 300 or less, still even more preferably 100 or less, still even more preferably 50 or less, and still even more preferably 10 or less. Therefore, in terms of reducing the embedded alumina following the rough polishing steps and protrusion defects following the final polishing step, the ratio between the silica particle content and the heterocyclic aromatic compound content of the polishing liquid composition B [silica particle content (wt %)/heterocyclic aromatic compound content (wt %)] is preferably 0.01 to 3,000, more preferably 0.05 to 3,000, still more preferably 1 to 1,000, even more preferably 2 to 750, still even more preferably 2 to 500, still even more preferably 2 to 300, still even more preferably 2 to 100, still even more preferably 2 to 50, still even more preferably 2 to 10, and still even more preferably 3 to 10.

[Polyvalent Amine Compound]

In terms of reducing the embedded alumina following the rough polishing steps and protrusion defects following the final polishing step, it is preferable that the polishing liquid composition B contains a polyvalent amine compound. It is considered that since a polyvalent amine compound carries positive electric charge, it adheres onto the substrate surface and forms a protective coat thereon, thereby preventing alumina from reattaching to the substrate surface.

In terms of operability in consideration of the odor and/or boiling point and reducing the embedded alumina and the waviness of the substrate surface following the rough polishing steps and protrusion defects and the waviness of the substrate following the final polishing step, the polyvalent amine compound has preferably 2 or more nitrogen atoms (N). Further, from the same viewpoints and in terms of maintaining the polishing removal rate, the polyvalent amine compound has preferably 20 or less, more preferably 5 or less, and still more preferably 3 or less nitrogen atoms (N). Therefore, all factors considered, the polyvalent amine compound has preferably 2 to 20, more preferably 2 to 5, and still more preferably 2 to 3 nitrogen atoms (N).

In terms of operability in consideration of the odor and/or boiling point, it is preferable that the polyvalent amine compound has a hydroxyl group. In terms of operability in consideration of the odor and/or boiling point and reducing protrusion defects of the substrate following the final polishing step, the polyvalent amine compound has preferably 1 or more, and more preferably 2 or more hydroxyl groups. Further, in terms of maintaining the polishing removal rate during the rough polishing steps, the polyvalent amine compound has preferably 5 or less, and more preferably 3 or less hydroxyl groups. Therefore, all factors considered, the polyvalent amine compound has preferably 1 to 5, more preferably 1 to 3, and still more preferably 2 to 3 hydroxyl groups.

When the polyvalent amine compound has both nitrogen atoms and hydroxyl groups, a total of nitrogen atoms and hydroxyl groups is preferably 2 to 10, more preferably 2 to 5, still more preferably 2 to 4, and even more preferably 3 to 4 in terms of reducing the embedded alumina and the waviness of the substrate surface following the rough polishing steps and protrusion defects and the waviness of the substrate following the final polishing step.

In terms of reducing the embedded alumina following the rough polishing steps and protrusion defects following the final polishing step, examples of preferred polyvalent amine compounds include: aliphatic amine compounds such as ethylene diamine, N,N,N,N′-tetramethyletheyelen diamine, 1,2-diaminopropane, 1,3-diaminopropane, 1,4-diaminobutane, hexamethylene diamine, 3-(diethylamino)propylamine, 3-(dibutylamino)propylamine, 3-(methylamino)propylamine, 3-(dimethylamino)propylamine, N-aminoethyl ethanolamine, N-aminoethyl isopropanolamine, N-aminoethyl-N-methylethanolamine, diethylenetriamine, and triethylene tertamine; and alicyclic amine compounds such as piperazine, 2-methylpiperazine, 2,5-dimethylpiperazine, N-methylpiperazine, N-(2-aminoethyl)piperazine, and hydroxyethyl piperazine. In particular, N-aminoethyl ethanolamine, N-aminoethyl isopropanolamine, N-aminoethyl-N-methylethanolamine, piperazine, N-(2-aminoethyl)piperazine, and hydroxyethyl piperazine are preferred, N-aminoethyl ethanolamine, N-(2-aminoethyl)piperazine, and hydroxyethyl piperazine are more preferred, N-aminoethyl ethanolamine and hydroxyethyl piperazine are still more preferred, and N-aminoethyl ethanolamine is even more preferred in terms of reducing the embedded alumina following the rough polishing steps, protrusion defects following the final polishing step, and amine odor, and improving the solubility in water. These polyvalent amine compounds can be used alone or in combination of two or more.

In terms of reducing the embedded alumina following the rough polishing steps and protrusion defects following the final polishing step, the polyvalent amine compound content of the polishing liquid composition B is preferably 0.001 wt % or more, more preferably 0.01 wt % or more, still more preferably 0.02 wt % or more, even more preferably 0.03 wt % or more, still even more preferably 0.05 wt % or more, still even more preferably 0.1 wt % or more, and still even more preferably 0.5 wt % or more. Further, from the same viewpoints, the polyvalent amine compound content is preferably 10 wt % or less, more preferably 5 wt % or less, still more preferably 2 wt % or less, and even more preferably 1 wt % or less. Therefore, in terms of reducing the embedded alumina following the rough polishing steps and protrusion defects following the final polishing step, the polyvalent amine compound content of the polishing liquid composition B is preferably 0.001 to 10 wt %, more preferably 0.01 to 5 wt %, still more preferably 0.02 to 2 wt %, even more preferably 0.03 to 2 wt %, still even more preferably 0.05 to 2 wt %, still even more preferably 0.1 to 2 wt %, and still even more preferably 0.5 to 1 wt %.

Further, in terms of reducing the embedded alumina following the rough polishing steps and protrusion defects following the final polishing step, the ratio between the silica particle content and polyvalent amine compound content of the polishing liquid composition [silica particle content (wt %)/polyvalent amine compound content (wt %)] is preferably 0.01 or more, more preferably 0.1 or more, still more preferably 1 or more, and even more preferably 2 or more, and preferably 30,000 or less, more preferably 10,000 or less, still more preferably 1,000 or less, even more preferably 500 or less, still even more preferably 100 or less, and still even more preferably 10 or less. Therefore, in terms of reducing the embedded alumina following the rough polishing steps and protrusion defects following the final polishing step, the ratio between the silica particle content and the polyvalent amine compound content of the polishing liquid composition [silica particle content (wt %)/polyvalent amine compound content (wt %)] is preferably 0.01 to 30,000, more preferably 0.1 to 10,000, still more preferably 0.1 to 1,000, even more preferably 1 to 500, still even more preferably 1 to 100, and still even more preferably 2 to 10.

Moreover, in terms of reducing the embedded alumina following the rough polishing steps and protrusion defects following the final polishing step, the ratio between the heterocyclic aromatic compound content and the polyvalent amine compound content of the polishing liquid composition B [heterocyclic aromatic compound content (wt %)/polyvalent amine compound content (wt %)] is preferably 0.001 to 10,000, more preferably 0.01 to 2,000, still more preferably 0.1 to 200, even more preferably 0.5 to 100, still even more preferably 1 to 50, still even more preferably 1 to 25, still even more preferably 1.5 to 15, and still even more preferably 0.8 to 2.

[Polymer Having Anionic Group]

In terms of reducing the embedded alumina following the rough polishing steps and protrusion defects following the final polishing step as well as reducing the waviness of the substrate surface, it is preferable that the polishing liquid composition B contains a polymer having an anionic group (hereinafter also referred to as an “anionic polymer”). It is considered that the anionic polymer adheres to a polishing pad during polishing and forms a hydration layer on the surface of the polishing pad, thereby suppressing vibrations of the polishing pad as well as further improving the dispersibility of alumina particles to suppress the embedded alumina. The anionic polymer is water soluble. Here, being “water soluble” means that the anionic polymer has solubility of 2 g or more in 100 g of water at 20° C.

Examples of anionic groups of the anionic polymer include carboxylic, sulfonic, sulfate, phosphate, and phosphonic groups. These anionic groups may be in the form of salt. In terms of reducing the embedded alumina following the rough polishing steps and protrusion defects following the final polishing step, the anionic polymer preferably includes at least one of sulfonic and carboxylic groups, and more preferably a sulfonic group.

When the anionic group is in the form of salt, the salt is not particularly limited. Specific examples of the salts include metal salt, ammonium salt, and alkylammonium salt. Specific examples of the metals include those belonging to Group 1A, 1B, 2A, 2B, 3A, 3B, 4A, 6A, 7A, and 8 in the periodic table (long period form). Specific examples of alkylammonium include tetramethyl ammonium, tetraethyl ammonium, and tetrabutyl ammonium. In particular, metals belonging to Group 1A, 3B or 8 and ammonium are preferred, metals belonging to Group 1A and ammonium are more preferred, and ammonium, sodium and potassium are more preferred in terms of reducing the embedded alumina following the rough polishing steps and protrusion defects following the final polishing step.

The anionic polymer can be obtained by the polymerization of monomers having anionic groups such as those having sulfonic groups and those having carboxylic groups. The polymerization of these monomers may be any of random, block, and graft polymerizations but random polymerization is preferred.

Specific examples of monomers having sulfonic groups include isoprene sulfonic acid, 2-(meth)acrylamide-2-methylpropane sulfonic acid, styrenesulfonic acid, methallylsulfonic acid, vinylsulfonic acid, allyl sulfonic acid, isoamylene sulfonic acid, and naphthalenesulfonic acid. In terms of reducing the embedded alumina following the rough polishing steps and protrusion defects following the final polishing step, 2-(meth)acrylamide-2-methylpropane sulfonic acid, styrenesulfonic acid, and naphthalenesulfonic acid are preferred. Examples of monomers having carboxylic groups include itaconic acid, (meth)acrylic acid, and maleic acid. In terms of reducing the embedded alumina following the rough polishing steps and protrusion defects following the final polishing step, (meth)acrylic acid is preferred. Examples of monomers having phosphate or phosphonic groups include vinylphosphonic acid, methacryloyloxymethyl phosphonic acid, methacryloyloxyethyl phosphonic acid, methacryloyloxybutyl phosphonic acid, methacryloyloxyhexyl phosphonic acid, methacryloyloxyoctyl phosphonic acid, methacryloyloxydecyl phosphonic acid, methacryloyloxylauryl phosphonic acid, methacryloyloxystearyl phosphonic acid, and methacryloyloxy, 1,4-dimethylcyclohexyl phosphonic acid.

For the anionic polymer, monomers other than those mentioned above can also be used. Examples of other monomers include: aromatic vinyl compounds such as styrene, α-methylstyrene, vinyltoluene, and p-methylstyrene; (meth)acrylic alkyl esters such as (meth)acrylic methyl, (meth)acrylic ethyl, and (meth)acrylic octyl; aliphatic conjugated dienes such as butadiene, isoprene, 2-chloro-1,3-butadiene, and 1-chloro-1,3-butadiene; and vinyl cyanide compounds such as (meth)acrylonitrile.

In term of reducing the embedded alumina following the rough polishing steps and protrusion defects following the final polishing step, specific preferred examples of the anionic polymer include polyacrylic acid, a copolymer of (meth)acrylic acid and isoprenesulfonic acid, a copolymer of (meth)acrylic acid and 2-(meth)acrylamide-2-methylpropane sulfonic acid, a copolymer of (meth)acrylic acid, isoprenesulfonic acid, and 2-(meth)acrylamide-2-methylpropane sulfonic acid, a copolymer of (meth)acrylic acid and maleic acid, naphthalene sulfonate formaldehyde condensate, methylnaphthalene sulfonate formaldehyde condensate, anthracene sulfonate formaldehyde condensate, melamine sulfonate formaldehyde condensate, lignosulfonic acid, modified lignosulfonic acid, aminoaryl sulfonic acid-phenol-formaldehyde condensate, a copolymer of styrene and isoprenesulfonic acid, a syrenesulfonic acid polymer, a copolymer of styrene and styrenesulfonic acid, and a copolymer of alkyl(meth)acrylate and styrenesulfonic acid. From the same viewpoints, the anionic polymer is preferably one or more selected from polyacrylic acid, a copolymer of (meth)acrylic acid and 2-(meth)acrylamide-2-methylpropane sulfonic acid, naphthalene sulfonate formaldehyde condensate, a copolymer of styrene and isoprenesulfonic acid, a syrenesulfonic acid polymer and a copolymer of styrene and styrenesulfonic acid, and more preferably one or more selected from a copolymer of (meth)acrylic acid and 2-(meth)acrylamide-2-methylpropane sulfonic acid, naphthalene sulfonate formaldehyde condensate, a syrenesulfonic acid polymer and a copolymer of styrene and styrenesulfonic acid.

When the anionic polymer is a copolymer of (meth)acrylic acid and 2-(meth)acrylamide-2-methylpropane sulfonic acid, constitutional units derived from 2-(meth)acrylamide-2-methylpropane sulfonic acid account for preferably 5 to 95 mol %, more preferably 5 to 90 mol %, still more preferably 5 to 85 mol %, even more preferably 10 to 80 mol %, still even more preferably 20 to 60 mol %, still even more preferably 30 to 50 mol %, and still even more preferably 40 to 50 mol % of all of the constitutional units of the copolymer in terms of reducing the embedded alumina following the rough polishing steps and protrusion defects following the final polishing step. Further, in terms of reducing the embedded alumina following the rough polishing steps and protrusion defects following the final polishing step, the molar ratio in polymerization between (meth)acrylic acid and 2-(meth)acrylamide-2-methylpropane sulfonic acid ((meth)acrylic acid/2-(meth)acrylamide-2-methylpropane sulfonic acid) is preferably 95/5 to 5/95, more preferably 95/5 to 10/90, still more preferably 95/5 to 15/85, even more preferably 95/5 to 20/80, still even more preferably 95/5 to 40/60, still even more preferably 95/5 to 50/50, still even more preferably 90/10 to 50/50, still even more preferably 80/20 to 50/50, still even more preferably 70/30 to 50/50, and still even more preferably 60/40 to 50/50.

Further, when the anionic polymer is a copolymer of styrene and styrenesulfonic acid, constitutional units derived from styrenesulfonic acid account for preferably 30 to 95 mol %, more preferably 35 to 90 mol %, still more preferably 40 to 85 mol %, and even more preferably 45 to 80 mol % of all of the constitutional units of the copolymer in terms of reducing the embedded alumina following the rough polishing steps and protrusion defects following the final polishing step. Further, in terms of reducing the embedded alumina following the rough polishing steps and protrusion defects following the final polishing step, the molar ratio in polymerization between styrene and styrenesulfonic acid (styrene/styrenesulfonic acid) is preferably 5/95 to 70/30, more preferably 10/90 to 65/35, still more preferably 15/85 to 60/40, even more preferably 20/80 to 55/45, and still even more preferably 40/60 to 55/45.

In terms of reducing the embedded alumina following the rough polishing steps and protrusion defects following the final polishing step, the anionic polymer has a weight-average molecular weight of preferably 500 or more, more preferably 1,000 or more; still more preferably 1,500 or more, and even more preferably 5,000 or more. Further, from the same viewpoints, the anionic polymer has a weight-average molecular weight of preferably 120,000 or less, more preferably 100,000 or less, still more preferably 30,000 or less, even more preferably 20,000 or less, and still even more preferably 10,000 or less. Therefore, in terms of reducing the embedded alumina following the rough polishing steps and protrusion defects following the final polishing step, the anionic polymer has a weight-average molecular weight of preferably 500 to 120,000, more preferably 1,000 to 100,000, still more preferably 1,000 to 30,000, even more preferably 1,500 to 30,000, still even more preferably 5,000 to 20,000, and still even more preferably 5,000 to 10,000. Further, when the anionic polymer is a copolymer of (meth)acrylic acid and 2-(meth)acrylamide-2-methylpropane sulfonic acid, the anionic polymer has a weight-average molecular weight of preferably 500 or more, more preferably 1,000 or more, still more preferably 1,500 or more, even more preferably 5,000 or more, and still even more preferably 8,000 or more, and preferably 120,000 or less, more preferably 100,000 or less, still more preferably 30,000 or less, even more preferably 20,000 or less, and still even more preferably 10,000 or less in terms of reducing the embedded alumina following the rough polishing steps and protrusion defects following the final polishing step. Therefore, when the anionic polymer is a copolymer of (meth)acrylic acid and 2-(meth)acrylamide-2-methylpropane sulfonic acid, the anionic polymer has a weight-average molecular weight of preferably 500 to 120,000, more preferably 500 to 30,000, still more preferably 1,000 to 30,000, even more preferably 1,500 to 30,000, still even more preferably 5,000 to 20,000, still even more preferably 8,000 to 20,000, and still even more preferably 8,000 to 10,000 in terms of reducing the embedded alumina following the rough polishing steps and protrusion defects following the final polishing step. The weight-average molecular weight can be determined by a method described in Examples using gel permeation chromatography (GPC).

In terms of reducing the embedded alumina following the rough polishing steps and protrusion defects following the final polishing step, the anionic polymer content of the polishing liquid composition B is preferably 0.001 wt % or more, more preferably 0.005 wt % or more, still more preferably 0.01 wt % or more, even more preferably 0.015 wt % or more, still even more preferably 0.02 wt % or more, and still even more preferably 0.05 wt % or more, and preferably 1 wt % or less, more preferably 0.5 wt % or less, still more preferably 0.2 wt % or less, and even more preferably 0.1 wt % or less. Therefore, in terms of reducing the embedded alumina following the rough polishing steps and protrusion defects following the final polishing step, the anionic polymer content of the polishing liquid composition B is preferably 0.001 to 1 wt %, more preferably 0.005 to 1 wt %, still more preferably 0.005 to 0.5 wt %, even more preferably 0.01 to 0.5 wt %, still even more preferably 0.015 to 0.5 wt %, still even more preferably 0.02 to 0.2 wt %, and still even more preferably 0.05 to 0.1 wt %.

Further, in terms of reducing the embedded alumina following the rough polishing steps and protrusion defects following the final polishing step, the ratio between the silica particle content and anionic polymer content of the polishing liquid composition B [silica particle content (wt %)/anionic polymer content (wt %)] is preferably 0.1 to 30,000, more preferably 0.5 to 10,000, still more preferably 1 to 5,000, even more preferably 5 to 2,500, even more preferably 20 to 1,000, still even more preferably 25 to 500, still even more preferably 25 to 100, and still even more preferably 25 to 50.

Moreover, in terms of reducing the embedded alumina following the rough polishing steps and protrusion defects following the final polishing step, the ratio between the heterocyclic aromatic compound content and the anionic polymer content of the polishing liquid composition B [heterocyclic aromatic compound content (wt %)/anionic polymer content (wt %)] is preferably 0.01 to 10,000, more preferably 0.05 to 1,000, still more preferably 0.1 to 100, even more preferably 0.5 to 100, still even more preferably 0.7 to 75, still even more preferably 0.7 to 50, still even more preferably 0.8 to 20, and still even more preferably 0.8 to 2.

Moreover, in terms of reducing the embedded alumina following the rough polishing step and protrusion defects following the final polishing step, the ratio between the polyvalent amine compound content and the anionic polymer content of the polishing liquid composition B [polyvalent amine compound content (wt %)/anionic polymer content (wt %)] is preferably 0.01 to 10,000, more preferably 0.05 to 1,000, still more preferably 0.1 to 500, even more preferably 0.5 to 100, still even more preferably 0.5 to 50, still even more preferably 0.6 to 25, still even more preferably 0.6 to 10, and still even more preferably 0.8 to 2.

In terms of improving the polishing removal rate and reducing the embedded alumina following the rough polishing steps and protrusion defects following the final polishing step, it is preferable that the polishing liquid composition B contains an acid and an oxidizing agent. Preferred acids and oxidizing agents are the same as those explained above in connection with the polishing liquid composition A. Water used in the polishing liquid composition B, the pH of the polishing liquid composition B, and the method for preparing the polishing liquid composition B are the same as those mentioned above in connection with the polishing liquid composition A.

[Polishing Liquid Composition C]

In terms of reducing protrusion defects following the final polishing step, the polishing liquid composition C used in the step (4) contains silica particles. The silica particles used in the polishing liquid composition C are the same as those used in the polishing liquid composition A, and are preferably of colloidal silica. Further, in terms of reducing the embedded alumina following the rough polishing steps and protrusion defects following the final polishing step, it is preferable that the polishing liquid composition C is free of alumina particles.

In terms of reducing protrusion defects following the final polishing step, silica particles used in the polishing liquid composition C have an average primary particle size (D10) of preferably 5 to 50 nm, more preferably 10 to 45 nm, still more preferably 15 to 40 nm, and even more preferably 20 to 35 nm. The average primary particle size can be determined by a method described in Examples.

Further, in terms of reducing protrusion defects following the final polishing steps, the primary particle size standard deviation of the silica particles is preferably 5 to 40 nm, more preferably 10 to 35 nm, and still more preferably 15 to 30 nm. The standard deviation can be determined by a method described in Examples.

In terms of reducing protrusion defects and the waviness of the substrate surface following the final polishing step and improving the polishing removal rate, the silica particles have a primary particle size (D10) of preferably 5 to 60 nm, more preferably 15 to 50 nm, still more preferably 20 to 45 nm, and even more preferably 25 to 35 nm. The primary particle size (D10) can be determined by a method described in Examples.

In terms of reducing protrusion defects and the waviness of the substrate surface following the final polishing step and improving the polishing removal rate, the silica particles have a primary particle size (D90) of preferably 10 to 70 nm, more preferably 20 to 60 nm, still more preferably 25 to 50 nm, and even more preferably 30 to 45 nm. The primary particle size (D90) can be determined by a method described in Examples.

In terms of reducing protrusion defects following the final polishing step, the silica particle content of the polishing liquid composition C is preferably 0.3 to 20 wt %, more preferably 0.5 to 20 wt %, still more preferably 1 to 15 wt %, even more preferably 1 to 10 wt %, still even more preferably 2 to 13 wt %, still even more preferably 2 to 10 wt %, and still even more preferably 2 to 6 wt %.

In terms of reducing protrusion defects following the final polishing step, the polishing liquid composition C contains preferably one or more and more preferably two or more selected from a heterocyclic aromatic compound, a polyvalent amine compound, and a polymer having an anionic group. It is even more preferable that the polishing liquid composition C contains a heterocyclic aromatic compound, a polyvalent amine compound, and a polymer having an anionic group. Preferred heterocyclic aromatic compounds, polyvalent amine compounds, and polymers having an anionic group to be used are the same as those mentioned above in connection with the polishing liquid composition B.

In terms of improving the polishing removal rate and reducing protrusion defects following the final polishing step, it is preferable that the polishing liquid composition C contains an acid and an oxidizing agent. Preferred acids and oxidizing agents to be used are the same as those mentioned above in connection with the polishing liquid composition A. Further, water used in the polishing liquid composition C, the pH of the polishing liquid composition C, and the method for preparing the polishing liquid composition C are the same as those mentioned above in connection with the polishing liquid composition A.

[Cleaning Composition]

In the cleaning step (3), it is preferable to use a detergent composition. As the detergent composition, one containing an alkaline agent, water, and, if needed, various additives can be used.

[Alkaline Agent]

The alkaline agent used in the detergent composition may be either an inorganic alkaline agent or an organic alkaline agent. Examples of inorganic alkaline agents include ammonium, potassium hydroxide, sodium hydroxide, and the like. At least one example of organic alkaline agents is selected from the group consisting of hydroxyalkyl amine, tetramethyl ammonium hydroxide and choline. These alkaline agents may be used alone or in combination of two or more.

In terms of improving the detergent composition's storage stability and its capability of washing off residues on the substrates, the alkaline agent is preferably at least one selected from the group consisting of potassium hydroxide, sodium hydroxide, monoethanol amine, methyldiethanol amine, and aminoethylethanol amine, and more preferably at least one selected from the group consisting of potassium hydroxide and sodium hydroxide.

In terms of enhancing the detergent composition's capability of cleaning residues on the substrates, and improving its level of safety at the time of handling, the alkaline agent content of the detergent composition is preferably 0.1 to 10 wt %, and more preferably 0.3 to 3 wt %.

In terms of improving the detergent composition's capability of dispersing residues on the substrates, the pH of the detergent composition is preferably 8 to 13, more preferably 9 to 13, still more preferably 10 to 13, and even more preferably 11 to 13 at 25° C. The pH can be measured by using a pH meter (HM-30G manufactured by DKK-TOA CORPORATION), and it indicates a numerical value taken 40 minutes after immersing an electrode of the pH meter in the detergent composition.

[Various Additives]

The detergent composition may contain nonionic surfactants, chelating agents, ether carboxylate or fatty acid, anionic surfactants, water soluble polymers, antifoaming agents (except surfactant contained as a component), alcohols, anticeptics, antioxidants, in addition to the alkaline agent.

In terms of improving the detergent composition's storage stability at the time of condensation and use and the detergent composition's capability of dispersing residues on the substrates, components other than water contained in the detergent composition is preferably 1 to 60 wt %, more preferably 15 to 50 wt %, and more preferably 15 to 40 wt %, where a total of water and the components other than water contained in the detergent composition is 100 wt %.

The detergent composition is diluted when being used. In view of washing efficiency, the dilution factor is preferably 10 to 500 fold, more preferably 20 to 200 fold, and still more preferably 50 to 100 fold. Water used for the dilution may be the same as that used for the aforementioned polishing liquid compositions.

According to the substrate production method of the present invention, it is possible to provide magnetic disk substrates in which the embedded alumina following the rough polishing steps and protrusion defects following the final polishing step are reduced. Therefore, the method can be suitably used in polishing magnetic disk substrates for the perpendicular magnetic recording system, which need to have a high level of surface smoothness.

[Polishing Method]

Viewed from another aspect, the present invention relates to a polishing method including the aforementioned steps (1), (2), (3) and (4). That is, viewed from another aspect, the present invention relates to a polishing method including the steps of: (1) supplying the polishing liquid composition A containing alumina particles and water to a polishing surface of a substrate to be polished, and polishing the polishing surface by brining a polishing pad into contact with the polishing surface and moving the polishing pad and/or the substrate to be polished; (2) supplying to the polishing surface of the substrate obtained in the step (1) the polishing liquid composition B containing water and silica particles having an average primary particle size (D50) of 5 to 60 nm and a primary particle size standard deviation of less than 40 nm, and polishing the polishing surface by brining a polishing pad into contact with the polishing surface and moving the polishing pad and/or the substrate to be polished; (3) cleaning the substrate obtained in the step (2); and (4) supplying the polishing liquid composition C containing silica particles and water to the polishing surface of the substrate obtained in the step (3), and polishing the polishing surface by brining a polishing pad into contact with the polishing surface and moving the polishing pad and/or the substrate to be polished. The substrate to be polished, the polishing pads, the compositions of the polishing liquid compositions A to C, the detergent composition and the polishing method and conditions thereof may be the same as those in the aforementioned substrate production method of the present invention.

By using the polishing method of the present invention, it is possible to provide in a preferable manner magnetic disc substrates, particularly, magnetic disk substrates for the perpendicular magnetic recording system in which the embedded alumina following the rough polishing steps and protrusion defects following the final polishing step are reduced. As mentioned above, the substrate to be polished in the polishing method includes those used in the production of magnetic disk substrates and substrates for magnetic recording media. In particular, substrates used in the production of magnetic disk substrates for the perpendicular magnetic recording system are preferred.

### EXAMPLES

Polishing liquid compositions A, B, and C were prepared in the following manner, and the steps (1), (2), (3), and (4) were carried out under the following conditions to polish substrates to be polished. Tables 4 to 7 provide the results. The methods for preparing the polishing liquid compositions, the additives used, the methods for measuring respective parameters, the polishing conditions (polishing methods) and the evaluation methods are as follows.

[Preparation of Polishing Liquid Compositions A]

Alumina abrasive grains A to D shown in Table 1, citric acid, sulfuric acid, hydrogen peroxide, water, and, in some instances, colloidal silica abrasive grains b to e shown in Table 2 and additives A-1 to A-4 shown in Table 3 were used to prepare polishing liquid compositions A (Tables 4 to 7 below). The amount of each component other than alumina and silica particles contained in each polishing liquid composition A was as follows: citric acid=0.2 wt %, sulfuric acid=0.4 wt %, and hydrogen peroxide=0.4 wt %. The pH of each polishing liquid composition was 1.4.

[Preparation of Polishing Liquid Compositions B]

Colloidal silica grains a to d and f to j shown in Table 2, sulfuric acid, hydrogen peroxide, water, and, in some instances, additives B-1 to D-2 shown in Table 3 were used to prepare polishing liquid compositions B (Tables 4 to 7 below). The amount of each component other than silica particles contained in each polishing liquid composition B was as follows: sulfuric acid=0.2 wt %, and hydrogen peroxide=0.2 wt %. The pH of each polishing liquid composition was 1.6.

[Preparation of Polishing Liquid Compositions C]

Colloidal silica c shown in Table 2, sulfuric acid, hydrogen peroxide, water, and additives B-1, C-1 and D-1 shown in Table 3 were used to prepare polishing liquid compositions C. The amount of each component contained in each polishing liquid composition C was as follows: colloidal silica c=3.0 wt %, sulfuric acid=0.3 wt %, hydrogen peroxide=0.3 wt %, additive B-1=0.01 wt %, additive C-1=0.01 wt %, and additive D-1=0.02 wt %. The pH of each polishing liquid composition was 1.5.

TABLE 1

| | | α-alumina | | | θ-alumina | |
|---|---|---|---|---|---|---|
| | Average | Percentage | Average | | Average | |
| | secondary | of | secondary | | secondary | |
| Alumina | particle | α-phase | particle size | Content | particle size | Content |
| particles | size (μm) | (%) | (μm) | (wt %) | (μm) | (wt %) |
| abrasive grain A | 0.78 | 96 | 0.80 | 80% | 0.16 | 20% |
| abrasive grain B | 0.62 | | 0.65 | 80% | | 20% |
| abrasive grain C | 0.48 | | 0.50 | 80% | | 20% |
| abrasive grain D | 0.29 | 65 | 0.30 | 80% | | 20% |

TABLE 2

| | | | | Primary particle |
|---|---|---|---|---|
| | Primary particle size | | | size standard |
| | (nm) | | | deviation |
| Colloidal silica | D10 | D50 | D90 | (nm) |
| abrasive grain a | 7 | 10 | 14 | 9 |
| abrasive grain b | 20 | 23 | 27 | 16 |
| abrasive grain c | 29 | 32 | 37 | 22 |
| abrasive grain d | 46 | 53 | 59 | 35 |
| abrasive grain e | 24 | 45 | 79 | 42 |
| abrasive grain f | 53 | 66 | 77 | 38 |
| abrasive grain g | 127 | 135 | 147 | 64 |
| abrasive grain h | 30 | 38 | 137 | 42 |
| abrasive grain i | 13 | 38 | 55 | 29 |
| abrasive grain j | 26 | 33 | 41 | 27 |

TABLE 3

| | Additives | |
|---|---|---|
| Diallylamine | Additive A-1 | copolymer of N,N-diallyl(N,N-dimethyl)ammonium chloride and sulfur |
| copolymers | | dioxide (molar ratio: 50/50, Mw = 5,000, manufactured by Nitto Boseki |
| | | Co., Ltd) |
| | Additive A-2 | copolymer of N,N-diallyl(N,N-dimethyl)ammonium chloride and |
| | | acrylamide (molar ratio: 50/50, Mw = 10,000, manufactured by Nitto |
| | | Boseki Co., Ltd) |
| | Additive A-3 | N,N-diallyl(N,N-dimethyl)ammonium chloride polymer |
| | | (Mw = 8,500, manufactured by Nitto Boseki Co., Ltd) |
| | Additive A-4 | N,N-diallyl(N-methyl)ammonium chloride polymer |
| | | (Mw = 5,000, manufactured by Nitto Boseki Co., Ltd) |
| Polymers having | Additive B-1 | sodium salt of copolymer of acrylic acid and |
| anionic group | | 2-acrylamide-2-methylpropane sulfonic acid (molar ratio: 90/10, |
| | | Mw = 2,000, manufactured by Toagosei Co., Ltd.) |
| | Additive B-2 | sodium salt of copolymer of acrylic acid and |
| | | 2-acrylamide-2-methylpropane sulfonic acid (molar ratio: 57/43, |
| | | Mw = 10,000, manufactured by Toagosei Co., Ltd.) |
| | Additive B-3 | sodium salt of copolymer of acrylic acid and |
| | | 2-acrylamide-2-methylpropane sulfonic acid (molar ratio: 5/95, |
| | | Mw = 7,000, manufactured by Toagosei Co., Ltd.) |
| | Additive B-4 | styrenesulfonic acid Na polymer |
| | | (Mw = 26,000, manufactured by Tosoh Organic Chemical Co., Ltd.) |
| | Additive B-5 | naphthalene sulfonate formaldehyde condensate |
| | | (Mw = 2,800, manufactured by Kao Corporation) |
| | Additive B-6 | sodium salt of copolymer of styrene and styrenesulfonic acid |
| | | (molar ratio: 50/50, Mw = 6,000) |
| Polyvalent amine | Additive C-1 | N-aminoethyl ethanolamine |
| compounds | | (manufactured by Waco Pure Chemical Industries, Ltd.) |
| | Additive C-2 | hydroxyethyl piperazine |
| | | (manufactured by Waco Pure Chemical Industries, Ltd.) |
| Heterocyclic | Additive D-1 | 1H-benzotriazol |
| aromatic | | (manufactured by Waco Pure Chemical Industries, Ltd) |
| compounds | Additive D-2 | pyrazole |
| | | (manufactured by Waco Pure Chemical Industries, Ltd.) |

### Production Example 1

### Production of Additive B-6

The additive B-6 shown in Table 3 above was produced as follows. A 1 L four-necked flask was charged with 180 g of isopropyl alcohol (manufactured by Kishida Chemical Co., Ltd.), 270 g of ion exchanged water, 18 g of styrene (manufactured by Kishida Chemical Co., Ltd.), and 32 g of sodium styrenesulfonate (manufactured by Wako Pure Chemical Industries, Ltd.), and then 8.9 g of 2,2′-azobis(2-methylpropionamidine)dihydrochloride (V-50, manufactured by Wako Pure Chemical Industries, Ltd.) was added to the flask as an initiator. They were polymerized for two hours at 83+2° C., further aged for two hours, and the solvent was thereafter removed under reduced pressure to give the additive B-6 in the form of a white powder. Commercial products were used as is as the additives other than the additive B-6.

[Measurement of Average Secondary Particle Size of Alumina Particles]

A 0.5% POIZ 530 (manufactured by Kao Corporation, a special polycarboxilic polymer surfactant) aqueous solution was put in the following measuring device as a dispersion medium, and then alumina particles were put in the device such that the transmittance would be 75 to 95%. Subsequently, ultrasound was applied to the alumina particles for 5 minutes, and then the particle size was determined.

Measuring device: laser beam diffraction/scattering particle size distribution analyzer LA-920 manufactured by HORIBA Ltd.
Circulation strength: 4
Ultrasonic intensity: 4

[Method for Measuring Percentage of α-Phase of Alumina]

20 g of alumina slurry was dried for 5 hours at 105° C., and the dried product was crushed with a mortar to obtain samples for powder X-ray diffraction. Each sample was analyzed by powder X-ray diffraction and the peak area of the 104 phase was compared with other. Measurement conditions under which the power X-ray diffraction was performed were as follows.

### Measurement Conditions

Device: powder X-ray analyzer RINT 2500VC manufactured by Rigaku Corporation
X-ray generation voltage: 40 kV

### Radiation: Cu—Kα1 ray (λ=0.154050 nm)

### Current: 120 mA

Scan Speed 10 degree/min
Measuring step: 0.02 degree/min
Percentage of α-phase (%)=peak area unique to α-alumina/peak area of WA-1000×100

Each peak area was calculated from the obtained powder X-ray diffraction spectrum using power X-ray diffraction pattern integrated analysis software JADE (manufactured by MDI Inc.) that was included in the power X-ray diffractometer. The calculation with this software was based on its instruction manual (Jade (Ver. 5) software, Manual No. MJ13133E02, Rigaku Corporation). Note that WA-1000 was α-alumina in which the percentage of α-phase was 99.9% (manufactured by Showa Denko K.K.)

[Measurement of Average Primary Particle Size and Primary Particle Size Standard Deviation of Silica Particles]

Silica particles were observed under a transmission electron microscope (TEM) (Trade name: “JEM-2000FX”, 80 kV, 10,000-50,000× manufactured by JEOL Ltd.), and the TEM images were photographed and scanned into a personal computer as image data using a scanner. Then, the diameter of a circle having the same area as the projected area of each silica particle was calculated for 1,000 or more silica particle data with analysis software “WinROOF (Ver. 3.6)” (commercially available from Mitani Corporation). Using the resultant diameters of the individual silica particles, the standard deviation (sample standard deviation) in volume-basis particle size was determined with spreadsheet software “EXCEL” (manufactured by Microsoft Corporation). Further, on the basis of the silica particle size distribution data obtained by converting the particle diameter into a particle volume with the spreadsheet software “EXCEL”, the percentage (percent by volume) of the particles having a certain particle size in the whole particles was expressed as a cumulative frequency from a smaller particle size side, thereby obtaining the cumulative volume frequency (%). On the basis of the particle size and the cumulative volume frequency data of the silica particles thus determined, the cumulative volume frequency was plotted against the particle size, so that a graph of particle size versus cumulative volume frequency was obtained. In this graph, a particle size at which the cumulative volume frequency of the silica particles from the smaller particle size side reaches 50% was defined as the average primary particle size (D50) of the silica particles. Further, a particle size at which the cumulative volume frequency of the silica particles from the smaller particle size side reaches 10% was defined as the primary particle size (D10) of the silica particles, and a particle size at which the cumulative volume frequency of the silica particles from the smaller particle size side reaches 90% was defined as the primary particle size (D90) of the silica particles.

[Method for Measuring Weight-Average Molecular Weight of Additives A and B]

The weight-average molecular weight of each of the additives A (A-1 to A-4) and B (B-1 to B-6) was measured by gel permeation chromatography (GPC) under the following conditions.

### <GPC Conditions for Additives A (A-1 to A-4)>

Measuring device: L-6000 high-speed liquid chromatogram (manufactured by Hitachi, Ltd.)

### Column: GS-220HQ+GS-620HQ (Asahipak)

Column temperature: 30° C.
Eluent 0.4 mol/L sodium chloride aqueous solution
Flow rate: 1.0 mL/min
Sample size: 5 mg/mL
Injection volume: 100 μL
Detector: RI (Shodex RISE-61 manufactured by Showa Denko K.K.)
Standard for Calculation: polyethylene glycol (molecular weight: 106; 194; 440; 600; 1,470; 4,100; 7,100; 10,300; 12,600; 23,000 (manufactured by American Polymer Standards Service Corp.))

### <GPC Conditions for Additives B (B-1 to B-3)>

Measuring device: HLC-8220 GPC (manufactured by Tosoh Corporation)
Column: TSKgel G4000PWXL+TSKgel G2500PWXL (manufactured by Tosoh Corporation)
Eluent 0.2M phosphate buffer/CH₃CN=9/1 (volume ratio)

### Temperature: 40° C.

Flow Rate: 1.0 mL/min
Sample Size: 5 mg/mL
Injection volume: 100 μL
Detector: RI (manufactured by Tosoh Corporation)
Standard for Calculation: sodium polyacrylate (molecular weight: 125; 4,100; 28,000; 115,000 (manufactured by Sowa Science Corporation and American Polymer Standards Service Corp.))

### <GPC Conditions for Additive B-4>

Measuring device: HLC-8220 GPC (manufactured by Tosoh Corporation)
Column: G4000SWXL+G2500SWXL (manufactured by Tosoh Corporation)
Eluent 0.2M phosphate buffer/CH₃CN=7/3 (volume ratio)

### Temperature: 40° C.

Flow Rate: 1.0 mL/min
Sample Size: 5 mg/mL
Injection volume: 100 μL
Detector: RI (manufactured by Tosoh Corporation)
Standard: polyethylene glycol (24,000; 101,000; 1085,000; 540,000; manufactured by Tosoh Corporation, 258,000; 875,000 manufactured by Sowa Science Corporation)

### <GPC Conditions for Additive B-5>

Measuring device: HLC-8220 GPC (manufactured by Tosoh Corporation)
Column: G4000SWXL+G2500SWXL (manufactured by Tosoh Corporation)
Eluent: 30 mM sodium acetate/CH₃CN=6/4 (volume ratio) (pH 6.9)

### Temperature: 40° C.

Flow Rate: 1.0 mL/min
Sample Size: 5 mg/mL
Injection volume: 100 μL
Detector: UV 280 nm (manufactured by Tosoh Corporation)
Standard: polystyrene (Mw 8,420,000; 96,400; A-500 (manufactured by Tosoh Corporation), Mw 30,000; 4,000 (manufactured by Nishio Kogyo Co. Ltd.) Mw 900,000 (manufactured by Chemco Scientific Co., Ltd.)

### <GPC Conditions for Additive B-6>

Measuring device: HLC-8120 GPC (manufactured by Tosoh Corporation)
Column: TSK gel α-M+TSK gel α-M (manufactured by Tosoh Corporation)
Guard column: TSK guard column a (manufactured by Tosoh Corporation)
Eluent: 60 mmol/L phosphoric acid, 50 mmol/L LiBr/DMF

### Temperature: 40° C.

Flow Rate: 1.0 mL/min
Sample Size: 3 mg/mL
Injection volume: 100 μL
Detector: RI (manufactured by Tosoh Corporation)
Standard for Calculation: polystyrene (molecular weight: 3,600; 30,000, (manufactured by Nishio Kogyo Co. Ltd.), 96,400; 8,420,000 (manufactured by Tosoh Corporation), 929,000 (manufactured by Chemco Scientific Co., Ltd.))

[Substrates to be Polished]

Ni—P plated aluminum alloy substrates were used as the substrates to be polished. The substrates to be polished each had a thickness of 1.27 mm and a diameter of 95 mm (donut shaped substrates having a hole with a diameter of 25 mm at the center).

[Polishing of Substrates to be Polished]

Polishing conditions in each step were as follows. The same polisher was used in the steps (1) and (2), and a polisher different from the one used in the steps (1) and (2) was used in the step (4).

[Polishing Conditions in Step (1)]

Polishing tester: double side polisher (Double side 9B polisher manufactured by SpeedFam Company Limited)
Polishing pad: suede type (foamed layer: polyurethane elastomer), thickness: 1.0 mm, average pore size: 43 μm (manufactured by FILWEL Co., Ltd.)
Number of revolutions of platen: 45 rpm
Polishing down force: 9.8 kPa (set value)
Amount of polishing liquid supplied: 100 mL/min (0.076 mL/(cm²·min))
Amount polished (one side): 1.0 to 1.2 mg/cm²
Number of substrates introduced: 10 (polished both sides)
Rinsing conditions:

Number of revolutions of platen: 45 rpm

Polishing down force: 9.8 kPa (set value)

Amount of ion exchanged water supplied: 2 L/min for 10 seconds

[Polishing Conditions in Step (2)]

Polishing tester: double side polisher (Double side 9B polisher manufactured by SpeedFam Company Limited, the same as in the step (1))
Polishing pad: suede type (foamed layer: polyurethane elastomer), thickness: 1.0 mm, average pore size: 43 μm (manufactured by FILWEL Co., Ltd., the same as in the step (1))
Number of revolutions of platen: 45 rpm
Polishing down force: 9.8 kPa (set value)
Amount of polishing liquid supplied: 100 mL/min (0.076 mL/(cm²·min))
Amount polished: 0.02 to 0.04 mg/cm²
Rinsing conditions:

Number of revolutions of platen: 20 rpm

Polishing down force: 1.4 kPa

Amount of ion exchanged water supplied: 2 L/min for 15 seconds

[Cleaning Conditions in Step (3)]

The substrates obtained in the step (2) were cleaned under the following conditions using a cleaning device.

1. For 5 minutes, the substrates were immersed in a vessel filled with an alkaline detergent composition having a pH of 12 and including 0.1 wt % KOH aqueous solution.
2. After being immersed, the substrates were rinsed with ion exchanged water for 20 seconds.
3. After being rinsed, the substrates were moved to a scrubbing cleaning unit equipped with a cleaning brush and they were cleaned.

[Polishing Conditions in Step (4)]

Polishing tester: double side polisher (Double side 9B polisher manufactured by SpeedFam Company Limited, a polisher different from the one used in the steps (1) and (2))
Polishing pad: suede type (foamed layer: polyurethane elastomer), thickness: 1.0 mm, average pore size: 5 μm (manufactured by FILWEL Co., Ltd.)
Number of revolutions of platen: 40 rpm
Polishing down force: 9.8 kPa (set value)
Amount of polishing liquid supplied: 100 mL/min (0.076 mL/(cm²·min))
Amount polished: 0.2 to 0.3 mg/cm²
Number of substrates introduced: 10 (double polishing)
The substrates were rinsed and cleaned after the step (4). After the step (4), the substrates were rinsed under the same conditions as in the step (2), and cleaned under the same conditions as in the step (3).

[Method for Evaluating Embedded Alumina Following Step (3)]

Measuring device: OSA7100 (manufactured by KLA-Tencor Corporation)
Evaluation: The substrates obtained in the step (3) were polished using the polishing liquid composition C (colloidal silica c) under the same conditions as in the step (4) except for changing the amount of polishing to 0.05 mg/cm², and then they were rinsed and cleaned. Thereafter, four substrates were randomly selected from the substrates, and each of the selected substrates was irradiated with laser light at 10,000 rpm, and the number of embedded alumina particles was measured. The total of alumina particles embedded into both sides of each of the four substrates was divided by 8 to give the number of embedded alumina particles per substrate surface. The results are provided in Tables 4 to 7 as relative values, with Comparative Example 1 taken as 100. Note that the substrates were rinsed under the same conditions as in the step (2) and they were cleaned under the same conditions as in the step (3).

[Method for Evaluating Protrusion Defects Following Step (4)]

Measuring device: OSA7100 (manufactured by KLA-Tencor Corporation)
Evaluation: From the substrates scrubbed and cleaned after the step (4) under the same conditions as in the step (3), four substrates were randomly selected, and each of the selected substrates was irradiated with laser light at 8,000 rpm, and the number of protrusion defects was measured. The total of protrusion defects on both sides of each of the four substrates was divided by 8 to give the number of protrusion defects per substrate surface. The results are provided in Tables 4 to 7 as relative values, with Comparative Example 1 taken as 100.

TABLE 4

| | | | | | | | | | Final | |
|---|---|---|---|---|---|---|---|---|---|---|
| | | | | | | | | | polishing | |
| | | | | | | | | | step (4) | |
| | | | | | | | | | Polishing | |
| | Rough polishing step (1) | | | | Rough polishing step (2) | | | | liquid | |
| | Polishing liquid | | | | Polishing liquid | | | After | composition | After final |
| | composition A | | | | composition B | | | cleaning | C | polishing |
| | | colloidal | | | colloidal | | | step (3) | colloidal | step (4) |
| | alumina | silica | | | silica | | | Embedding | silica | Number of |
| | abrasive | abrasive | | polishing | abrasive | | polishing | of | abrasive | protrusion |
| | grain | grain | | down | grain | | down | alumina | grain | defects |
| | No. | No. | additive | force | No. | additive | force | (relative | No. | (relative |
| | (wt %) | (wt %) | (wt %) | (kPa) | (wt %) | (wt %) | (kPa) | value) | (wt %) | value) |
| Ex. 1 | A | — | — | 9.8 | a | — | 9.8 | 87 | c | 88 |
| | (5.0%) | | | | (3.0%) | | | | (3.0%) | |
| Ex. 2 | A | — | — | 9.8 | b | — | 9.8 | 81 | c | 81 |
| | (5.0%) | | | | (3.0%) | | | | (3.0%) | |
| Ex. 3 | A | — | — | 9.8 | c | — | 9.8 | 90 | c | 88 |
| | (5.0%) | | | | (3.0%) | | | | (3.0%) | |
| Ex. 4 | A | — | — | 9.8 | d | — | 9.8 | 92 | c | 90 |
| | (5.0%) | | | | (3.0%) | | | | (3.0%) | |
| Ex. 5 | A | — | — | 9.8 | i | — | 9.8 | 86 | c | 86 |
| | (5.0%) | | | | (3.0%) | | | | (3.0%) | |
| Ex. 6 | A | — | — | 9.8 | j | — | 9.8 | 85 | c | 84 |
| | (5.0%) | | | | (3.0%) | | | | (3.0%) | |
| Ex. 7 | C | e | — | 9.8 | b | — | 9.8 | 16 | c | 15 |
| | (3.0%) | (2.0%) | | | (3.0%) | | | | (3.0%) | |
| Ex. 8 | C | e | — | 9.8 | c | — | 9.8 | 18 | c | 17 |
| | (3.0%) | (2.0%) | | | (3.0%) | | | | (3.0%) | |
| Ex. 9 | C | e | — | 9.8 | d | — | 9.8 | 20 | c | 18 |
| | (3.0%) | (2.0%) | | | (3.0%) | | | | (3.0%) | |
| Ex. 10 | c | e | — | 9.8 | i | — | 9.8 | 18 | c | 16 |
| | (3.0%) | (2.0%) | | | (3.0%) | | | | (3.0%) | |
| Ex. 11 | C | e | — | 9.8 | j | — | 9.8 | 17 | c | 18 |
| | (3.0%) | (2.0%) | | | (3.0%) | | | | (3.0%) | |
| Ex. 12 | D | d | — | 9.8 | i | — | 9.8 | 10 | c | 14 |
| | (1.0%) | (4.0%) | | | (6.0%) | | | | (3.0%) | |
| Ex. 13 | D | d | — | 9.8 | j | — | 9.8 | 9 | c | 10 |
| | (1.0%) | (4.0%) | | | (5.0%) | | | | (3.0%) | |
| Ex. 14 | C | e | — | 9.8 | b | — | 9.8 | 17 | c | 16 |
| | (3.0%) | (2.0%) | | | (1.0%) | | | | (3.0%) | |
| Ex. 15 | C | e | — | 9.8 | b | — | 9.8 | 16 | c | 14 |
| | (3.0%) | (2.0%) | | | (5.0%) | | | | (3.0%) | |
| Ex. 16 | C | e | — | 9.8 | b | — | 9.8 | 14 | c | 13 |
| | (3.0%) | (2.0%) | | | (10.0%) | | | | (3.0%) | |
| Ex. 17 | C | e | — | 9.8 | b | — | 9.8 | 20 | c | 19 |
| | (3.0%) | (2.0%) | | | (15.0%) | | | | (3.0%) | |
| Ex. 18 | B | — | — | 9.8 | c | — | 9.8 | 61 | c | 6 |
| | (5.0%) | | | | (3.0%) | | | | (3.0%) | |
| Ex. 19 | C | — | — | 9.8 | c | — | 9.8 | 37 | c | 34 |
| | (5.0%) | | | | (3.0%) | | | | (3.0%) | |
| Ex. 20 | D | — | — | 9.8 | c | — | 9.8 | 14 | c | 13 |
| | (5.0%) | | | | (3.0%) | | | | (3.0%) | |
| Ex. 21 | B | e | — | 9.8 | b | — | 9.8 | 20 | c | 19 |
| | (4.0%) | (1.0%) | | | (3.0%) | | | | (3.0%) | |
| Ex 22 | B | b | — | 9.8 | b | — | 9.8 | 18 | c | 18 |
| | (4.0%) | (1.0%) | | | (3.0%) | | | | (3.0%) | |
| Ex. 23 | B | c | — | 9.8 | b | — | 9.8 | 22 | c | 20 |
| | (4.0%) | (1.0%) | | | (3.0%) | | | | (3.0%) | |
| Ex. 24 | B | d | — | 9.8 | b | — | 9.8 | 24 | c | 26 |
| | (4.0%) | (1.0%) | | | (3.0%) | | | | (3.0%) | |
| Ex. 25 | D | e | — | 9.8 | b | — | 9.8 | 6 | c | 6 |
| | (1.0%) | (4.0%) | | | (3.0%) | | | | (3.0%) | |
| Comp. | B | e | — | 9.8 | — | — | — | 100 | c | 100 |
| Ex. 1 | (4.0%) | (1.0%) | | | | | | | (3.0%) | |
| Ref. | A | — | — | 9.8 | g | — | 9.8 | 130 | c | 134 |
| Ex. 1 | (5.0%) | | | | (3.0%) | | | | (3.0%) | |
| Ref. | A | — | — | 9.8 | f | — | 9.8 | 127 | c | 126 |
| Ex. 2 | (5.0%) | | | | (3.0%) | | | | (3.0%) | |
| Ref. | A | — | — | 9.8 | h | — | 9.8 | 124 | c | 127 |
| Ex. 3 | (6.0%) | | | | (3.0%) | | | | (3.0%) | |

TABLE 5

| | | | | | | | | | Final | |
|---|---|---|---|---|---|---|---|---|---|---|
| | | | | | | | | | polishing | |
| | | | | | | | | | step (4) | |
| | | | | | | | | | Polishing | |
| | Rough polishing step (1) | | | | Rough polishing step (2) | | | | liquid | |
| | Polishing liquid | | | | Polishing liquid | | | After | composition | After final |
| | composition A | | | | composition B | | | cleaning | C | polishing |
| | | colloidal | | | colloidal | | | step (3) | colloidal | step (4) |
| | alumina | silica | | | silica | | | Embedding | silica | Number of |
| | abrasive | abrasive | | polishing | abrasive | | polishing | of | abrasive | protrusion |
| | grain | grain | | down | grain | | down | alumina | grain | defects |
| | No. | No. | additive | force | No. | additive | force | (relative | No. | (relative |
| | (wt %) | (wt %) | (wt %) | (kPa) | (wt %) | (wt %) | (kPa) | value) | (wt %) | value) |
| Ex. 1 | A | — | — | 9.8 | a | — | 9.8 | 87 | c | 88 |
| | (5.0%) | | | | (3.0%) | | | | (3.0%) | |
| Ex. 26 | A | — | A-1 | 9.8 | b | — | 9.8 | 41 | c | 38 |
| | (5.0%) | | (0.01%) | | (3.0%) | | | | (3.0%) | |
| Ex. 27 | A | — | A-2 | 9.8 | b | — | 9.8 | 41 | c | 39 |
| | (5.0%) | | (0.01%) | | (3.0%) | | | | (3.0%) | |
| Ex. 28 | A | — | A-3 | 9.8 | b | — | 9.8 | 43 | c | 39 |
| | (5.0%) | | (0.01%) | | (3.0%) | | | | (3.0%) | |
| Ex. 29 | A | — | A-4 | 9.8 | b | — | 9.8 | 54 | c | 50 |
| | (5.0%) | | (0.01%) | | (3.0%) | | | | (3.0%) | |

TABLE 6

| | | | | | | | | | Final | |
|---|---|---|---|---|---|---|---|---|---|---|
| | | | | | | | | | polishing | |
| | | | | | | | | | step (4) | |
| | | | | | | | | | Polishing | |
| | Rough polishing step (1) | | | | Rough polishing step (2) | | | | liquid | |
| | Polishing liquid | | | | Polishing liquid | | | After | composition | After final |
| | composition A | | | | composition B | | | cleaning | C | polishing |
| | | colloidal | | | colloidal | | | step (3) | colloidal | step (4) |
| | alumina | silica | | | silica | | | Embedding | silica | Number of |
| | abrasive | abrasive | | polishing | abrasive | | polishing | of | abrasive | protrusion |
| | grain | grain | | down | grain | | down | alumina | grain | defects |
| | No. | No. | additive | force | No. | additive | force | (relative | No. | (relative |
| | (wt %) | (wt %) | (wt %) | (kPa) | (wt %) | (wt %) | (kPa) | value) | (wt %) | value) |
| Ex. 2 | A | — | — | 9.8 | b | — | 9.8 | 81 | c | 81 |
| | (5.0%) | | | | (3.0%) | | | | (3.0%) | |
| Ex. 30 | A | — | — | 9.8 | b | B-1 | 9.8 | 63 | c | 64 |
| | (5.0%) | | | | (3.0%) | (0.03%) | | | (3.0%) | |
| Ex. 31 | A | — | — | 9.8 | b | B-2 | 9.8 | 61 | c | 62 |
| | (5.0%) | | | | (3.0%) | (0.03%) | | | (3.0%) | |
| Ex. 32 | A | — | — | 9.8 | b | B-3 | 9.8 | 66 | c | 65 |
| | (5.0%) | | | | (3.0%) | (0.03%) | | | (3.0%) | |
| Ex. 33 | A | — | — | 9.8 | b | B-4 | 9.8 | 67 | c | 67 |
| | (5.0%) | | | | (3.0%) | (0.03%) | | | (3.0%) | |
| Ex. 34 | A | — | — | 9.8 | b | B-5 | 9.8 | 65 | c | 65 |
| | (5.0%) | | | | (3.0%) | (0.03%) | | | (3.0%) | |
| Ex. 35 | A | — | — | 9.8 | b | B-6 | 9.8 | 64 | c | 54 |
| | (5.0%) | | | | (3.0%) | (0.03%) | | | (3.0%) | |
| Ex. 11 | C | e | — | 9.8 | j | — | 9.8 | 17 | c | 18 |
| | (3.0%) | (2.0%) | | | (3.0%) | | | | (3.0%) | |
| Ex. 36 | C | e | — | 9.8 | j | B-1 | 9.8 | 13 | c | 14 |
| | (3.0%) | (2.0%) | | | (3.0%) | (0.03%) | | | (3.0%) | |
| Ex. 37 | C | e | — | 9.8 | j | B-2 | 9.8 | 12 | c | 13 |
| | (3.0%) | (2.0%) | | | (3.0%) | (0.03%) | | | (3.0%) | |
| Ex. 38 | C | e | — | 9.8 | j | B-4 | 9.8 | 14 | c | 15 |
| | (3.0%) | (2.0%) | | | (3.0%) | (0.03%) | | | (3.0%) | |
| Ex. 39 | C | e | — | 9.8 | j | B-5 | 9.8 | 13 | c | 14 |
| | (3.0%) | (2.0%) | | | (3.0%) | (0.03%) | | | (3.0%) | |
| Ex. 40 | C | e | — | 9.8 | j | B-16 | 9.8 | 13 | c | 12 |
| | (3.0%) | (2.0%) | | | (3.0%) | (0.03%) | | | (3.0%) | |
| Ex. 41 | C | e | A-1 | 9.8 | b | B-1 | 9.8 | 7 | c | 6 |
| | (3.0%) | (2.0%) | (0.01%) | | (3.0%) | (0.03%) | | | (3.0%) | |
| Ex. 42 | C | e | A-1 | 9.8 | b | B-6 | 9.8 | 7 | c | 7 |
| | (3.0%) | (2.0%) | (0.01%) | | (3.0%) | (0.03%) | | | (3.0%) | |
| Ex. 7 | C | e | — | 9.8 | b | — | 9.8 | 16 | c | 15 |
| | (3.0%) | (2.0%) | | | (3.0%) | | | | (3.0%) | |
| Ex. 43 | C | e | — | 9.8 | b | B-1 | 9.8 | 15 | c | 14 |
| | (3.0%) | (2.0%) | | | (3.0%) | (0.005%) | | | (3.0%) | |
| Ex. 44 | C | e | — | 9.8 | b | B-1 | 9.8 | 13 | c | 13 |
| | (5.0%) | (2.0%) | | | (3.0%) | (0.01%) | | | (3.0%) | |
| Ex. 45 | C | e | — | 9.8 | b | B-1 | 9.8 | 12 | c | 11 |
| | (3.0%) | (2.0%) | | | (3.0%) | (0.03%) | | | (3.0%) | |
| Ex. 46 | C | e | — | 9.8 | b | B-1 | 9.8 | 11 | c | 10 |
| | (3.0%) | (2.0%) | | | (3.0%) | (0.1%) | | | (3.0%) | |
| Ex. 47 | C | e | — | 9.8 | b | B-1 | 9.8 | 12 | c | 15 |
| | (3.0%) | (2.0%) | | | (3.0%) | (1.0%) | | | (3.0%) | |

TABLE 7

| | | | | | | | | | Final | |
|---|---|---|---|---|---|---|---|---|---|---|
| | | | | | | | | | polishing | |
| | | | | | | | | | step (4) | |
| | | | | | | | | | Polishing | |
| | Rough polishing step (1) | | | | Rough polishing step (2) | | | | liquid | |
| | Polishing liquid | | | | Polishing liquid | | | After | composition | After final |
| | composition A | | | | composition B | | | cleaning | C | polishing |
| | | colloidal | | | colloidal | | | step (3) | colloidal | step (4) |
| | alumina | silica | | | silica | | | Embedding | silica | Number of |
| | abrasive | abrasive | | polishing | abrasive | | polishing | of | abrasive | protrusion |
| | grain | grain | | down | grain | | down | alumina | grain | defects |
| | No. | No. | additive | force | No. | additive | force | (relative | No. | (relative |
| | (wt %) | (wt %) | (wt %) | (kPa) | (wt %) | (wt %) | (kPa) | value) | (wt %) | value) |
| Ex. 1 | A | — | — | 9.8 | a | — | 9.8 | 87 | c | 88 |
| | (5.0%) | | | | (3.0%) | | | | (3.0%) | |
| Ex. 9 | C | e | — | 9.8 | d | — | 9.8 | 20 | c | 18 |
| | (3.0%) | (2.0%) | | | (3.0%) | | | | (3.0%) | |
| Ex. 48 | C | e | — | 9.8 | d | C-1 | 9.8 | 16 | c | 14 |
| | (3.0%) | (2.0%) | | | (3.0%) | (0.005%) | | | (3.0%) | |
| Ex. 49 | C | e | — | 9.8 | d | C-1 | 9.8 | 15 | c | 13 |
| | (3.0%) | (2.0%) | | | (3.0%) | (0.01%) | | | (3.0%) | |
| Ex. 50 | C | e | — | 9.8 | d | C-1 | 9.8 | 14 | c | 12 |
| | (3.0%) | (2.0%) | | | (3.0%) | (0.1%) | | | (3.0%) | |
| Ex. 51 | C | e | — | 9.8 | d | C-1 | 9.8 | 13 | c | 11 |
| | (3.0%) | (2.0%) | | | (3.0%) | (1%) | | | (3.0%) | |
| Ex. 52 | C | e | — | 9.8 | d | C-2 | 9.8 | 17 | c | 14 |
| | (3.0%) | (2.0%) | | | (3.0%) | (0.01%) | | | (3.0%) | |
| Ex. 53 | C | e | A-1 | 9.8 | b | C-1 | 9.8 | 7 | c | 8 |
| | (3.0%) | (2.0%) | (0.01%) | | (3.0%) | (0.03%) | | | (3.0%) | |
| Ex. 54 | C | e | A-1 | 9.8 | b | C-2 | 9.8 | 9 | c | 10 |
| | (3.0%) | (2.0%) | (0.01%) | | (3.0%) | (0.03%) | | | (3.0%) | |
| Ex. 55 | A | — | — | 9.8 | i | D-1 | 9.8 | 69 | c | 65 |
| | (5.0%) | | | | (3.0%) | (0.005%) | | | (3.0%) | |
| Ex. 56 | A | — | — | 9.8 | i | D-1 | 9.8 | 65 | c | 64 |
| | (5.0%) | | | | (3.0%) | (0.01%) | | | (3.0%) | |
| Ex. 57 | A | — | — | 9.8 | i | D-1 | 9.8 | 60 | c | 60 |
| | (5.0%) | | | | (3.0%) | (0.1%) | | | (3.0%) | |
| Ex. 58 | A | — | — | 9.8 | i | D-1 | 9.8 | 58 | c | 56 |
| | (5.0%) | | | | (3.0%) | (1%) | | | (3.0%) | |
| Ex. 59 | A | — | — | 9.8 | i | D-1 | 9.8 | 64 | c | 62 |
| | (5.0%) | | | | (3.0%) | (5%) | | | (3.0%) | |
| Ex. 60 | A | — | — | 9.8 | i | D-2 | 9.8 | 70 | c | 70 |
| | (5.0%) | | | | (3.0%) | (0.01%) | | | (3.0%) | |
| Ex. 61 | C | e | A-1 | 9.8 | b | D-1 | 9.8 | 9 | c | 10 |
| | (3.0%) | (2.0%) | (0.01%) | | (3.0%) | (0.03%) | | | (3.0%) | |
| Ex. 62 | C | e | A-1 | 9.8 | b | D-2 | 9.8 | 9 | c | 9 |
| | (3.0%) | (2.0%) | (0.01%) | | (3.0%) | (0.03%) | | | (3.0%) | |
| Ex. 63 | C | e | A-1 | 9.8 | b | B-1 | 9.8 | 8 | c | 9 |
| | (3.0%) | (2.0%) | (0.01%) | | (3.0%) | (0.01%) | | | (3.0%) | |
| | | | | | | C-1 | | | | |
| | | | | | | (0.01%) | | | | |
| Ex. 64 | C | e | A-1 | 9.8 | b | B-1 | 9.8 | 6 | c | 6 |
| | (3.0%) | (2.0%) | (0.01%) | | (3.0%) | (0.01%) | | | (3.0%) | |
| | | | | | | C-1 | | | | |
| | | | | | | (0.01%) | | | | |
| | | | | | | D-1 | | | | |
| | | | | | | (0.01%) | | | | |

As can be seen from Tables 4 to 7, it was shown that the substrate production methods of Examples 1 to 64 resulted in less embedded alumina particles following the step (3) (following the rough polishing steps) and less protrusion defects following the step (4) (following the final polishing step) as compared to the substrate production methods of Comparative Example 1 and Reference Examples 1 to 3. Further, as can be seen from Tables 5 to 7, it was shown that the embedded alumina following the step (3) (following the rough polishing step) and protrusion defects following the step (4) (following the final polishing step) were further reduced because of the addition of the additives A (diallylamine copolymer) to the polishing liquid compositions A. Furthermore, as can be seen from Tables 6 to 7, it was shown that the embedded alumina following the step (3) (following the rough polishing step) and protrusion defects following the step (4) (following the final polishing step) were further reduced because of the addition of the additives B (polymers having an anionic group), C (polyvalent amine compounds) and D (heterocyclic aromatic compounds) to the polishing liquid compositions B.

[Verifying Importance of Having all of Steps (1) to (4)]

Substrate production methods (Comparative Examples 1 to 3) not including any one of the rough polishing step (2), the cleaning step (3) and the final polishing step (4) of the substrate production method of Example 21 (Table 4) were performed, and the number of protrusion defects following the step (4) was evaluated in the same manner as in Example 1. The results are provided in Table 8 as relative values, with the number of protrusion defects in Comparative Example 1 being taken as 100.

TABLE 8

| | | | Rough polishing | | Final polishing | |
|---|---|---|---|---|---|---|
| | Rough polishing step (1) | | step (2) | | step (4) | |
| | Polishing liquid | | Polishing liquid | | Polishing liquid | Number of |
| | composition A | | composition B | | composition C | protrusion |
| | Alumina | colloidal silica | Colloidal silica | | Colloidal silica | defects |
| | abrasive grain | abrasive grain | abrasive grain | Cleaning | abrasive grain | after final |
| | No. | No. | No. | step | No. | polishing |
| | (wt %) | (wt %) | (wt %) | (3) | (wt %) | step (4) |
| Ex. 1 | A | — | a | Yes | c | 88 |
| | (5.0%) | | (3.0%) | | (3.0%) | |
| Ex. 21 | B | e | b | Yes | c | 19 |
| | (4.0%) | (1.0%) | (3.0%) | | (3.0%) | |
| Comp. | B | e | — | Yes | c | 100 |
| Ex. 1 | (4.0%) | (1.0%) | | | (3.0%) | |
| Comp. | B | e | b | — | c | 290 |
| Ex. 2 | (4.0%) | (1.0%) | (3.0%) | | (3.0%) | |
| Comp. | B | e | b | Yes | — | >10000 |
| Ex. 3 | (4.0%) | (1.0%) | (3.0%) | | | |

As can be seen from Table 8, it was found that the substrate production method of the present invention was able to reduce the embedded alumina following the step (3) (following the rough polishing step) and protrusion defects following the step (4) (following the final polishing step) because it had all of the steps (1) to (4).

When substrates have a large number of protrusion defects and a high level of substrate surface waviness, they cannot be used as substrates for magnetic disks in the actual production, so that they need to be re-polished or thrown away. Therefore, the present invention's effects of reducing protrusion defects and substrate surface waviness following the final polishing step are expected to improve substrate yields.

### INDUSTRIAL APPLICABILITY

The substrate production method of the present invention can be suitably used for the production of magnetic disk substrates used in memory hard drives and the like.

Viewed from one or more aspects, the present invention may relate to the following:

<1>

A method for producing a magnetic disk substrate, the method comprising the steps of:

(1) supplying a polishing liquid composition A containing alumina particles and water to a polishing surface of a substrate to be polished, and polishing the polishing surface by brining a polishing pad into contact with the polishing surface and moving the polishing pad and/or the substrate to be polished;

(2) supplying to the polishing surface of the substrate obtained in the step (1) a polishing liquid composition B containing water and silica particles having an average primary particle size (D50) of 5 to 60 nm and a primary particle size standard deviation of less than 40 nm, and polishing the polishing surface by brining a polishing pad into contact with the polishing surface and moving the polishing pad and/or the substrate to be polished;

(3) cleaning the substrate obtained in the step (2); and

(4) supplying a polishing liquid composition C containing silica particles and water to the polishing surface of the substrate obtained in the step (3): and polishing the polishing surface by brining a polishing pad into contact with the polishing surface and moving the polishing pad and/or the substrate to be polished;

<2>

The method for producing a magnetic disk substrate according to <1>, further comprising the step of rinsing the substrate to be polished between the steps (1) and (2);

<3>

The method for producing a magnetic disk substrate according to <1> or <2>, wherein a polishing down force in the step (1) is 30 kPa or less, preferably 25 kPa or less, more preferably 20 kPa or less, still more preferably 18 kPa or less, even more preferably 16 kPa or less, still even more preferably 14 kPa or less, and still even more preferably 12 kPa or less, and/or 3 kPa or more, preferably 5 kPa or more, more preferably 7 kPa or more, still more preferably 8 kPa or more, and even more preferably 9 kPa or more, and/or 3 to 30 kPa, preferably 5 to 25 kPa, more preferably 7 to 20 kPa, still more preferably 8 to 18 kPa, even more preferably 9 to 16 kPa, still even more preferably 9 to 14 kPa, and still even more preferably 9 to 12 kPa;

<4>

The method for producing a magnetic disk substrate according to any one of <1> to <3>, wherein the amount of polishing per unit area (1 cm²) of the substrate to be polished in the step (1) is 0.4 mg or more, preferably 0.6 mg or more, and more preferably 0.8 mg or more, and/or 2.6 mg or less, preferably 2.1 mg or less, and more preferably 1.7 mg or less, and/or 0.4 to 2.6 mg, preferably 0.6 to 2.1 mg, and more preferably 0.8 to 1.7 mg;

<5>

The method for producing a magnetic disk substrate according to any one of <1> to <4>, wherein the alumina particles in the polishing liquid composition A used in the step (1) is of α-alumina, intermediate alumina, amorphous alumina, or fumed alumina, preferably a combination of α-alumina and intermediate alumina, and more preferably a combination of α-alumina and θ-alumina;

<6>

The method for producing a magnetic disk substrate according to <5>, wherein the weight ratio between the α-alumina and the intermediate alumina in the polishing liquid composition A (wt % of α-alumina/wt % of intermediate alumina) used in the step (1) is 90/10 to 10/90, preferably 85/15 to 40/60, more preferably 85/15 to 50/50, still more preferably 85/15 to 60/40, even more preferably 85/15 to 70/30, and still even more preferably 80/20 to 75/25;

<7>

The method for producing a magnetic disk substrate according to any one of <1> to <6>, wherein the alumina particles in the polishing liquid composition A used in the step (1) have an average secondary particle size of 0.1 to 0.8 μm, preferably 0.1 to 0.75 μm, more preferably 0.1 to 0.7 μm, still more preferably 0.15 to 0.7 μm, even more preferably 0.2 to 0.7 μm, still even more preferably 0.2 to 0.68 μm, still even more preferably 0.2 to 0.65 μm, still even more preferably 0.25 to 0.55 μm, and still even more preferably 0.25 to 0.40 μm;

<8>

The method for producing a magnetic disk substrate according to any one of <1> to <7>, wherein the alumina particle content of the polishing liquid composition A used in the step (1) is 0.01 to 30 wt %, preferably 0.05 to 20 wt %, more preferably 0.1 to 15 wt %, still more preferably 1 to 10 wt %, and even more preferably 1 to 6 wt %;

<9>

The method for producing a magnetic disk substrate according to any one of <1> to <8>, wherein the polishing liquid composition A used in the step (1) further contains silica particles;

<10>

The method for producing a magnetic disk substrate according to <9>, wherein the silica particles in the polishing liquid composition A used in the step (1) have an average primary particle size (D50) of 5 to 150 nm, preferably 10 to 130 nm, more preferably 20 to 120 nm, still more preferably 20 to 100 nm, even more preferably 20 to 60 nm, and still even more preferably 20 to 50 nm;

<11>

The method for producing a magnetic disk substrate according to <9> or <10>, wherein the primary particle size standard deviation of the silica particles in the polishing liquid composition A used in the step (1) is 8 to 55 nm, more preferably 10 to 50 nm, and still more preferably 15 to 45 nm;

<12>

The method for producing a magnetic disk substrate according to any one of <9> to <11>, wherein the weight ratio between the alumina particles and the silica particles (weight of alumina particles/weight of silica particles) in the polishing liquid composition A used in the step (1) is 10/90 to 80/20, preferably 15/85 to 75/25, more preferably 20/80 to 65/35, and still more preferably 20/80 to 60/40;

<13>

The method for producing a magnetic disk substrate according to any one of <9> to <12>, wherein the ratio between the average secondary particle size (D50) of the alumina particles and the average primary particle size (D50) of the silica particles (average secondary particle size of alumina/average primary particle size of silica) in the polishing liquid composition A used in the step (1) is 1 to 100, preferably 2 to 50, more preferably 4 to 40, and still more preferably 5 to 30;

<14>

The method for producing a magnetic disk substrate according to any one of <1> to <13>, wherein the polishing liquid composition A used in the step (1) contains a diallylamine polymer;

<15>

The method for producing a magnetic disk substrate according to <14>, wherein the diallylamine polymer in the polishing liquid composition A used in the step (1) has one or more constitutional units selected from the constitutional units represented by the general formulae (I-a), (I-b), (I-c), and (I-d);

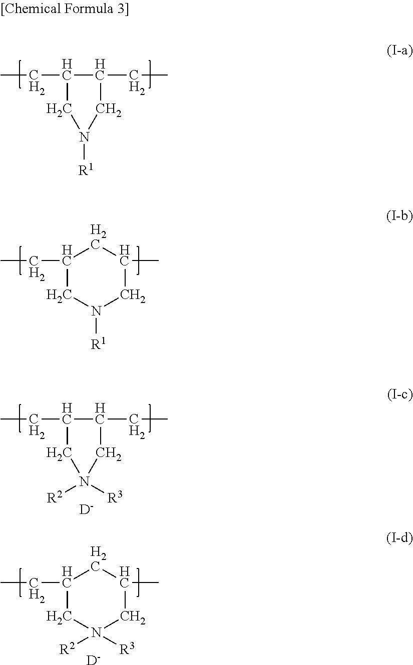

[where R¹ in the general formulae (I-a) and (I-b) is a hydrogen atom, a C₁₋₁₀ alkyl group or C₇₋₁₀ aralkyl group that may have a hydroxyl group, R² in the general formulae (I-c) and (I-d) is a C₁₋₁₀ alkyl group or C₇₋₁₀ aralkyl group that may have a hydroxyl group, and R³ is a C₁₋₄ alkyl group or a C₇₋₁₀ aralkyl group, and D⁻ is a monovalent anion];
<16>

The method for producing a magnetic disk substrate according to <15>, wherein the constitutional units represented by the general formulae (I-a), (I-b), (I-c) and (I-d) together account for 30 to 100 mol %, preferably 35 to 90 mol %, more preferably 40 to 80 mol %, and still more preferably 40 to 60 mol % of all of the constitutional units of the diallyl amine polymer in the polishing liquid composition A used in the step (1);

<17>

The method for producing a magnetic disk substrate according to any one of <14> to <16>, wherein the diallylamine polymer in the polishing liquid composition A used in the step (1) further includes the constitutional unit represented by the following general formula (II);

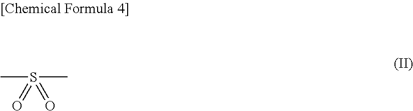

<18>

The method for producing a magnetic disk substrate according to <17>, wherein of all of the constitutional units of the diallylamine polymer in the polishing liquid composition A used in the step (1) the molar ratio between the constitutional units represented by the general formulae (I-a) to (I-d) and the constitutional unit represented by the general formula (II) (general formulae (I-a) to (I-d)/general formula (II)) is 100/0 to 30/70, preferably 90/10 to 30/70, more preferably 80/20 to 40/60, still more preferably 70/30 to 40/60, and even more preferably 60/40 to 40/60;

<19>

The method for producing a magnetic disk substrate according to any one of <14> to <18>, wherein the diallylamine polymer content of the polishing liquid composition A used in the step (1) is 0.001 wt % or more, preferably 0.005 wt % or more, and more preferably 0.01 wt % or more, and/or 1.0 wt % or less, preferably 0.5 wt % or less, more preferably 0.3 wt % or less, still more preferably 0.1 wt % or less, and even more preferably 0.05 wt % or less, and/or 0.001 to 1.0 wt %, preferably 0.005 to 0.5 wt %, more preferably 0.01 to 0.3 wt %, still more preferably 0.01 to 0.1 wt %, and even more preferably 0.01 to 0.05 wt %;

<20>

The method for producing a magnetic disk substrate according to any one of <1> to <19>, wherein the pH of the polishing liquid composition A used in the step (1) is 1 to 6, preferably 1 to 4, more preferably 1 to 3, and still more preferably 1 to 2;

<21>

The method for producing a magnetic disk substrate according to any one of <1> to <20>, wherein the polishing down force in the step (2) is 18 kPa or less, preferably 15 kPa or less, more preferably 13 kPa or less, and still more preferably 11 kPa or less, and/or 3 kPa or more, preferably 5 kPa or more, more preferably 6 kPa or more, and still more preferably 7 kPa or more, and/or 3 to 18 kPa, preferably 5 to 15 kPa, more preferably 6 to 13 kPa, and still more preferably 7 to 11 kPa;

<22>

The method for producing a magnetic disk substrate according to any one of <1> to <21>, wherein the amount of polishing per unit area (1 cm²) of the substrate to be polished in the step (2) is 0.0004 mg or more, preferably 0.004 mg or more, and more preferably 0.01 mg or more, and/or 0.85 mg or less, preferably 0.43 mg or less, more preferably 0.26 mg or less, and still more preferably 0.1 mg or less, and/or 0.0004 to 0.85 mg, preferably 0.004 to 0.43 mg, more preferably 0.01 to 0.26 mg, and still more preferably 0.01 to 0.1 mg;

<23>

The method for producing a magnetic disk substrate according to any one of <1> to <22>, wherein the silica particles in the polishing liquid composition B used in the step (2) have an average primary particle size (D50) of 5 nm or more, preferably 7 nm or more, more preferably 10 nm or more, and still more preferably 15 nm or more, and/or 60 nm or less, preferably 55 nm or less, more preferably 50 nm or less, still more preferably 45 nm or less, even more preferably 40 nm or less, and still even more preferably 30 nm or less, and/or 5 to 60 nm, preferably 7 to 55 nm, more preferably 10 to 50 nm, still more preferably 15 to 45 nm, even more preferably 15 to 40 nm, and still even more preferably 15 to 30 nm;

<24>

The method for producing a magnetic disk substrate according to any one of <1> to <23>, wherein the primary particle size standard deviation of the silica particles in the polishing liquid composition B used in the step (2) is less than 40 nm, preferably 39 nm or less, more preferably 35 nm or less, still more preferably 30 nm or less, and even more preferably 20 nm or less, and/or 5 nm or more, preferably 7 nm or more, more preferably 10 nm or more, and still more preferably 15 nm or more, and/or preferably 5 nm or more and less than 40 nm, more preferably 5 to 39 nm, still more preferably 7 to 35 nm, even more preferably 10 to 30 nm, and still even more preferably 15 to 20 nm;

<25>

The method for producing a magnetic disk substrate according to any one of <1> to <24>, wherein the silica particle content of the polishing liquid composition B used in the step (2) is 0.1 wt % or more, preferably 0.5 wt % or more, more preferably 1 wt % or more, still more preferably 2 wt % or more, and/or 30 wt % or less, preferably 25 wt % or less, more preferably 20 wt % or less, still more preferably 15 wt % or less, and even more preferably 10 wt % or less, and/or 0.1 to 30 wt %, preferably 0.5 to 25 wt %, more preferably 1 to 20 wt %, still more preferably 2 to 15 wt %, and even more preferably 2 to 10 wt %;

<26>

The method for producing a magnetic disk substrate according to any one of <1> to <25>, wherein the polishing liquid composition B used in the step (2) contains a heterocyclic aromatic compound;

<27>

The method for producing a magnetic disk substrate according to <26>, wherein the heterocyclic aromatic compound in the polishing liquid composition B used in the step (2) is pyrimidine, pyrazine, pyridazine, pyridine, 1,2,3-triazine, 1,2,4-triazine, 1,2,5-triazine, 1,3,5-triazine, 1,2,4-oxadiazole, 1,2,5-oxadiazole, 1,3,4-oxadiazole, 1,2,5-thiadiazole, 1,3,4-thiadiazole, 3-aminopyrazole, 4-aminopyrazole, 3,5-dimethylpyrazole, pyrazole, 2-aminoimidazole, 4-aminoimidazole, 5-aminoimidazole, 2-methylimidazole, 2-ethylimidazole, imidazole, benzoimidazole, 1,2,3-triazole, 4-amino-1,2,3-triazole, 5-amino-1,2,3-triazole, 1,2,4-triazole, 3-amino-1,2,4-triazole, 5-amino-1,2,4-triazole, 3-mercapto-1,2,4-triazole, 1H-tetrazole, 5-aminotetrazole, 1H-benzotriazole, 1H-tolyltriazole, 2-aminobenzotriazole, 3-aminobenzotriazole, or an alkyl-substituted or amine-substituted product thereof, preferably 1H-tetrazole, 1H-benzotriazole, 1H-tolyltriazole, or pyrazole, more preferably 1H-tetrazole, 1H-benzotriazole, or pyrazole, and still more preferably 1H-benzotriazole, or pyrazole;

<28>

The method for producing a magnetic disk substrate according to <26> or <27>, wherein the heterocyclic aromatic compound content of the polishing liquid composition B used in the step (2) is 0.001 wt % or more, preferably 0.005 wt % or more, more preferably 0.01 wt % or more, and still more preferably 0.1 wt % or more, and/or 8 wt % or less, preferably 5 wt % or less, more preferably 3 wt % or less, still more preferably 2 wt % or less, and even more preferably 1 wt % or less, and/or 0.001 to 8 wt %, preferably 0.001 to 5 wt %, more preferably 0.005 to 5 wt %, still more preferably 0.01 to 5 wt %, even more preferably 0.01 to 3 wt %, still even more preferably 0.1 to 3 wt %, still even more preferably 0.1 to 2 wt %, and still even more preferably 0.1 to 1 wt %;

<29>

The method for producing a magnetic disk substrate according to any one of <26> to <28>, wherein the ratio between the silica particle content and the heterocyclic aromatic compound content [silica particle content (wt %)/heterocyclic aromatic compound content (wt %)] of the polishing liquid composition B used in the step (2) is 0.01 or more, preferably 0.5 or more, more preferably 1 or more, still more preferably 2 or more, and even more preferably 3 or more, and/or 3,000 or less, preferably 1,000 or less, more preferably 750 or less, still more preferably 500 or less, even more preferably 300 or less, still even more preferably 100 or less, still even more preferably 50 or less, and still even more preferably 10 or less, and/or 0.01 to 3,000, preferably 0.05 to 3,000, more preferably 1 to 1,000, still more preferably 2 to 750, even more preferably 2 to 500, still even more preferably 2 to 300, still even more preferably 2 to 100, still even more preferably 2 to 50, still even more preferably 2 to 10, and still even more preferably 3 to 10;

<30>

The method for producing a magnetic disk substrate according to any one of <1> to <29>, wherein the polishing liquid composition B used in the step (2) contains a polyvalent amine compound;

<31>

The method for producing a magnetic disk substrate according to <30>, wherein the polyvalent amine compound in the polishing liquid composition B used in the step (2) includes 2 or more, and/or 20 or less, preferably 5 or less, and more preferably 3 or less, and/or 2 to 20, preferably 2 to 5, and more preferably 2 to 3 nitrogen atoms (N);

<32>

The method for producing a magnetic disk substrate according to <30> or <31>, wherein the polyvalent amine compound in the polishing liquid composition B used in the step (2) is an aliphatic amine compound or alicyclic amine compound, preferably ethylene diamine, N,N,N′,N′-tetramethyletheyelen diamine, 1,2-diaminopropane, 1,3-diaminopropane, 1,4-diaminobutane, hexamethylene diamine, 3-(diethylamino)propylamine, 3-(dibutylamino)propylamine, 3-(methylamino)propylamine, 3-(dimethylamino)propylamine, N-aminoethyl ethanolamine, N-aminoethyl isopropanolamine, N-aminoethyl-N-methylethanolamine, diethylenetriamine, triethylene tertamine, piperazine, 2-methylpiperazine, 2,5-dimethylpiperazine, N-methylpiperazine, N-(2-aminoethyl)piperazine, or hydroxyethyl piperazine, more preferably N-aminoethyl ethanolamine, N-aminoethyl isopropanolamine, N-aminoethyl-N-methylethanolamine, piperazine, N-(2-aminoethyl)piperazine, or hydroxyethyl piperazine, still more preferably N-aminoethyl ethanolamine, N-(2-aminoethyl)piperazine, or hydroxyethyl piperazine, even more preferably N-aminoethyl ethanolamine or hydroxyethyl piperazine, and still even more preferably N-aminoethyl ethanolamine;

<33>

The method for producing a magnetic disk substrate according to any one of <30> to <32>, wherein the polyvalent amine compound content of the polishing liquid composition B used in the step (2) is 0.001 wt % or more, preferably 0.01 wt % or more, more preferably 0.02 wt % or more, still more preferably 0.03 wt % or more, even more preferably 0.05 wt % or more, still even more preferably 0.1 wt % or more, and still even more preferably 0.5 wt % or more, and/or 10 wt % or less, preferably 5 wt % or less, more preferably 2 wt % or less, and still more preferably 1 wt % or less, and/or 0.001 to 10 wt %, preferably 0.01 to 5 wt %, more preferably 0.02 to 2 wt %, still more preferably 0.03 to 2 wt %, even more preferably 0.05 to 2 wt %, still even more preferably 0.1 to 2 wt %, and still even more preferably 0.5 to 1 wt %;

<34>

The method for producing a magnetic disk substrate according to any one of <30> to <33>, wherein the ratio between the silica particle content and the polyvalent amine compound content [silica particle content (wt %)/polyvalent amine compound content (wt %)] of the polishing liquid composition B used in the step (2) is 0.01 or more, preferably 0.1 or more, more preferably 1 or more, and still more preferably 2 or more, and/or 30,000 or less, preferably 10,000 or less, more preferably 1,000 or less, still more preferably 500 or less, even more preferably 100 or less, and still even more preferably 10 or less, and/or 0.01 to 30,000, preferably 0.1 to 10,000, more preferably 0.1 to 1,000, still more preferably 1 to 500, even more preferably 1 to 100, and still even more preferably 2 to 10;

<35>

The method for producing a magnetic disk substrate according to any one of <30> to <34>, wherein the ratio between the polycyclic aromatic compound content and the polyvalent amine compound content [polycyclic aromatic compound content (wt %)/polyvalent amine compound content (wt %)] of the polishing liquid composition B used in the step (2) is 0.001 to 10,000, preferably 0.01 to 2,000, more preferably 0.1 to 200, still more preferably 0.5 to 100, even more preferably 1 to 50, still even more preferably 1 to 25, still even more preferably 1.5 to 15, and still even more preferably 0.8 to 2;

<36>

The method for producing a magnetic disk substrate according to any one of <1> to <35>, wherein the polishing liquid composition B used in the step (2) contains a polymer having an anionic group;

<37>

The method for producing a magnetic disk substrate according to <36>, wherein the polymer having an anionic group in the polishing liquid composition B used in the step (2) is water soluble;

<38>

The method for producing a magnetic disk substrate according to <36> or <37>, wherein the polymer having an anionic group in the polishing liquid composition B used in the step (2) is a polymer having a carboxylic, sulfonic, sulfate, phosphate, or phosphonic group, preferably a polymer having at least one of sulfonic and carboxylic groups, and more preferably a polymer having a sulfonic group;

<39>

The method for producing a magnetic disk substrate according to any one of <36> to <38>, wherein the polymer having an anionic group in the polishing liquid composition B used in the step (2) is polyacrylic acid, a copolymer of (meth)acrylic acid and isoprenesulfonic acid, a copolymer of (meth)acrylic acid and 2-(meth)acrylamide-2-methylpropane sulfonic acid, a copolymer of (meth)acrylic acid, isoprenesulfonic acid, and 2-(meth)acrylamide-2-methylpropane sulfonic acid, a copolymer of (meth)acrylic acid and maleic acid, naphthalene sulfonate formaldehyde condensate, methylnaphthalene sulfonate formaldehyde condensate, anthracene sulfonate formaldehyde condensate, melamine sulfonate formaldehyde condensate, lignosulfonic acid, modified lignosulfonic acid, aminoarylsulfonic acid-phenol formaldehyde condensate, a copolymer of styrene and isoprenesulfonic acid, a syrenesulfonic acid polymer, a copolymer of styrene and styrenesulfonic acid, or a copolymer of (meth)acrylate alkylester and styrenesulfonic acid, preferably one or more selected from polyacrylic acid, a copolymer of (meth)acrylic acid and 2-(meth)acrylamide-2-methylpropane sulfonic acid, naphthalene sulfonate formaldehyde condensate, a copolymer of styrene and isoprenesulfonic acid, a syrenesulfonic acid polymer and a copolymer of styrene and styrenesulfonic acid, and more preferably one or more selected from a copolymer of (meth)acrylic acid and 2-(meth)acrylamide-2-methylpropane sulfonic acid, naphthalene sulfonate formaldehyde condensate, a syrenesulfonic acid polymer and a copolymer of styrene and styrenesulfonic acid;

<40>

The method for producing a magnetic disk substrate according to any one of <36> to <39>, wherein the polymer having an anionic group in the polishing liquid composition B used in the step (2) has a weight-average molecular weight of 500 or more, preferably 1,000 or more, more preferably 1,500 or more, and still more preferably 5,000 or more, and/or 120,000 or less, preferably 100,000 or less, more preferably 30,000 or less, still more preferably 20,000 or less, and even more preferably 10,000 or less, and/or 500 to 120,000, preferably 1,000 to 100,000, more preferably 1,000 to 30,000, still more preferably 1,500 to 30,000, even more preferably 5,000 to 20,000, and still even more preferably 5,000 to 10,000, and

when the polymer having an anionic group is a copolymer of (meth)acrylic acid and 2-(meth)acrylamide-2-methylpropane sulfonic acid, the polymer having an anionic group has a weight-average molecular weight of 500 or more, preferably 1,000 or more, more preferably 1,500 or more, still more preferably 5,000 or more, even more preferably 8,000 or more, and/or 120,000 or less, preferably 100,000 or less, more preferably 30,000 or less, still more preferably 20,000 or less, and even more preferably 10,000 or less, and/or 500 to 120,000, preferably 500 to 30,000, more preferably 1,000 to 30,000, still more preferably 1,500 to 30,000, even more preferably 5,000 to 20,000, still even more preferably 8,000 to 20,000, and still even more preferably 8,000 to 10,000;

<41>

The method for producing a magnetic disk substrate according to any one of <36> to <40>, wherein the content of the polymer having an anionic group in the polishing liquid composition B used in the step (2) is 0.001 wt % or more, preferably 0.005 wt % or more, more preferably 0.01 wt % or more, still more preferably 0.015 wt % or more, even more preferably 0.02 wt % or more, and still even more preferably 0.05 wt % or more, and/or 1 wt % or less, preferably 0.5 wt % or less, more preferably 0.2 wt % or less, and still more preferably 0.1 wt % or less, and/or 0.001 to 1 wt %, preferably 0.005 to 1 wt %, more preferably 0.005 to 0.5 wt %, still more preferably 0.01 to 0.5 wt %, even more preferably 0.015 to 0.5 wt %, still even more preferably 0.02 to 0.2 wt %, and still even more preferably 0.05 to 0.1 wt %;

<42>

The method for producing a magnetic disk substrate according to any one of <36> to <41>, wherein the ratio between the silica particle content and the content of the polymer having an anionic group [silica particle content (wt %)/anionic polymer content (wt %)] of the polishing liquid composition B used in the step (2) is 0.1 to 30,000, preferably 0.5 to 10,000, more preferably 1 to 5,000, more preferably 5 to 2,500, still more preferably 20 to 1,000, even more preferably 25 to 500, still even more preferably 25 to 100, and still even more preferably 25 to 50;

<43>

The method for producing a magnetic disk substrate according to any one of <36> to <42>, wherein the ratio between the heterocyclic aromatic compound content and the content of the polymer having an anionic group [heterocyclic aromatic compound content (wt %)/anionic polymer content (wt %)] of the polishing liquid composition B used in the step (2) is 0.01 to 10,000, preferably 0.05 to 1,000, more preferably 0.1 to 100, more preferably 0.5 to 100, still more preferably 0.7 to 75, even more preferably 0.7 to 50, still even more preferably 0.8 to 20, and still even more preferably 0.8 to 2;

<44>

The method for producing a magnetic disk substrate according to any one of <36> to <43>, wherein the ratio between the polyvalent amine compound content and the content of the polymer having an anionic group [polyvalent amine compound content (wt %)/anionic polymer content (wt %)] of the polishing liquid composition B used in the step (2) is 0.01 to 10,000, preferably 0.05 to 1,000, more preferably 0.1 to 500, more preferably 0.5 to 100, still more preferably 0.5 to 50, even more preferably 0.6 to 25, still even more preferably 0.6 to 10, and still even more preferably 0.8 to 2;

<45>

The method for producing a magnetic disk substrate according to any one of <1> to <44>, wherein the polishing liquid composition B used in the step (2) has a pH of 1 to 6, preferably 1 to 4, more preferably 1 to 3, and still more preferably 1 to 2;

<46>

The method for producing a magnetic disk substrate according to any one of <1> to <45>, wherein a detergent composition containing an alkaline agent is used in the cleaning step (3), and the alkaline agent content of the detergent composition is 0.1 to 10 wt %, and preferably 0.3 to 3 wt %;

<47>

The method for producing a magnetic disk substrate according to any one of <1> to <46>, wherein a detergent composition containing an alkaline agent is used in the cleaning step (3), and the detergent composition has a pH of 8 to 13, preferably 9 to 13, more preferably 10 to 13, and still more preferably 11 to 13;

<48>

The method for producing a magnetic disk substrate according to any one of <1> to <47>, wherein a polishing down force in the step (4) is 16 kPa or less, preferably 14 kPa or less, more preferably 13 kPa or less, and more preferably 12 kPa or less, and/or 7.5 kPa or more, preferably 8.5 kPa or more, and more preferably 9.5 kPa or more, and/or 7.5 to 16 kPa, preferably 8.5 to 14 kPa, more preferably 9.5 to 13 kPa, and still more preferably 9.5 to 12 kPa;

<49>

The method for producing a magnetic disk substrate according to any one of <1> to <48>, wherein the amount of polishing per unit area (1 cm²) of the substrate to be polished in the step (4) is 0.085 mg or more, preferably 0.13 mg or more, and more preferably 0.17 mg or more, and/or 0.85 mg or less, preferably 0.6 mg or less, and more preferably 0.43 mg or less, and/or 0.085 to 0.85 mg, preferably 0.13 to 0.6 mg, and more preferably 0.17 to 0.43 mg;

<50>

The method for producing a magnetic disk substrate according to any one of <1> to <48>, wherein the silica particles in the polishing liquid composition C used in the step (4) have an average primary particle size (D50) of 5 to 50 nm, preferably 10 to 45 nm, more preferably 15 to 40 nm, and still more preferably 20 to 35 nm;

<51>

The method for producing a magnetic disk substrate according to any one of <1> to <50>, wherein the primary particle size standard deviation of the silica particles in the polishing liquid composition C used in the step (4) is 5 to 40 nm, preferably 10 to 35 nm, and more preferably 15 to 30 nm;

<52>

The method for producing a magnetic disk substrate according to any one of <1> to <51>, wherein the polishing liquid composition C used in the step (4) has a pH of 1 to 6, preferably 1 to 4, more preferably 1 to 3, and still more preferably 1 to 2;

<53>

The method for producing a magnetic disk substrate according to any one of <1> to <52>, wherein the substrate to be polished is an Ni—P plated aluminum alloy substrate or a glass substrate including silicate glass, aluminosilicate glass, crystallized glass or tempered glass, and is preferably an Ni—P plated aluminum alloy substrate;

<54>

A method for polishing a magnetic disk substrate, the method comprising the steps of:

(1) supplying a polishing liquid composition A containing alumina particles and water to a polishing surface of a substrate to be polished, and polishing the polishing surface by brining a polishing pad into contact with the polishing surface and moving the polishing pad and/or the substrate to be polished;

(2) supplying to the polishing surface of the substrate obtained in the step (1) a polishing liquid composition B containing water and silica particles having an average primary particle size (D50) of 5 to 60 nm and a primary particle size standard deviation of less than 40 nm, and polishing the polishing surface by brining a polishing pad into contact with the polishing surface and moving the polishing pad and/or the substrate to be polished;

(3) cleaning the substrate obtained in the step (2); and

(4) supplying a polishing liquid composition C containing silica particles and water to the polishing surface of the substrate obtained in the step (3), and polishing the polishing surface by brining a polishing pad into contact with the polishing surface and moving the polishing pad and/or the substrate to be polished;

<55>

The method for polishing a magnetic disk substrate according to <54>, wherein the method for producing a magnetic disk substrate according to <2> to <53> is a polishing method.

1. A method for producing a magnetic disk substrate, the method comprising the steps of:
(1) supplying a polishing liquid composition A containing alumina particles and water to a polishing surface of a substrate to be polished, and polishing the polishing surface by brining a polishing pad into contact with the polishing surface and moving the polishing pad and/or the substrate to be polished;
(2) supplying to the polishing surface of the substrate obtained in the step (1) a polishing liquid composition B containing water and silica particles having an average primary particle size (D50) of 5 to 60 nm and a primary particle size standard deviation of less than 40 nm, and polishing the polishing surface by brining a polishing pad into contact with the polishing surface and moving the polishing pad and/or the substrate to be polished;
(3) cleaning the substrate obtained in the step (2); and
(4) supplying a polishing liquid composition C containing silica particles and water to the polishing surface of the substrate obtained in the step (3), and polishing the polishing surface by brining a polishing pad into contact with the polishing surface and moving the polishing pad and/or the substrate to be polished.

2. The method for producing a magnetic disk substrate according to claim 1, wherein the polishing liquid composition A further contains silica particles.

3. The method for producing a magnetic disk substrate according to claim 1, wherein the polishing liquid composition A contains a diallyl amine polymer.

4. The method for producing a magnetic disk substrate according to claim 1, wherein the polishing liquid composition B contains a polymer having an anionic group.

5. The method for producing a magnetic disk substrate according to claim 1, wherein the polishing liquid composition B contains a heterocyclic aromatic compound.

6. The method for producing a magnetic disk substrate according to claim 1, wherein the polishing liquid composition B contains a polyvalent amine compound.

7. The method for producing a magnetic disk substrate according to claim 1, wherein the substrate to be polished is an Ni—P plated aluminum alloy substrate.

8. A method for polishing a magnetic disk substrate, the method comprising the steps of:
(1) supplying a polishing liquid composition A containing alumina particles and water to a polishing surface of a substrate to be polished, and polishing the polishing surface by brining a polishing pad into contact with the polishing surface and moving the polishing pad and/or the substrate to be polished;
(2) supplying to the polishing surface of the substrate obtained in the step (1) a polishing liquid composition B containing water and silica particles having an average primary particle size (D50) of 5 to 60 nm and a primary particle size standard deviation of less than 40 nm, and polishing the polishing surface by brining a polishing pad into contact with the polishing surface and moving the polishing pad and/or the substrate to be polished;
(3) cleaning the substrate obtained in the step (2); and
(4) supplying a polishing liquid composition C containing silica particles and water to the polishing surface of the substrate obtained in the step (3), and polishing the polishing surface by brining a polishing pad into contact with the polishing surface and moving the polishing pad and/or the substrate to be polished.

9. The method for polishing a magnetic disk substrate according to claim 8, wherein the substrate to be polished is an Ni—P plated aluminum alloy substrate.

10. The method for producing a magnetic disk substrate according to claim 1, further comprising, between the steps (1) and (2), the step of rinsing the substrate to be polished.

11. The method for producing a magnetic disk substrate according to claim 1, wherein a detergent composition containing an alkaline agent is used in the cleaning step (3), and the alkaline agent content of the detergent composition is 0.1 to 10 wt %, and the detergent composition has a pH of 8 to 13.

12. The method for producing a magnetic disk substrate according to claim 3, wherein the diallyl amine polymer contained in the polishing liquid composition A used in the step (1) includes one or more constitutional units represented by the following general formulas (I-a), (I-b), (I-c), and (I-d):

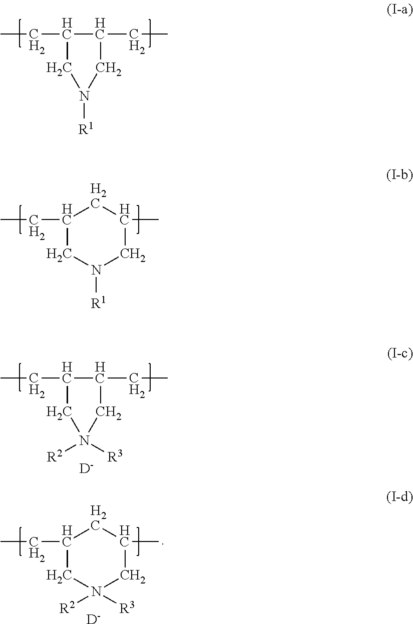

13. The method for producing a magnetic disk substrate according to claim 12, wherein the diallyl amine polymer contained in the polishing liquid composition A used in the step (1) further includes a constitutional unit represented by the following general formula (II):

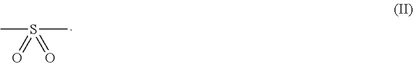

14. The method for producing a magnetic disk substrate according to claim 13, wherein in the diallyl amine polymer contained in the polishing liquid composition A used in the step (1), the molar ratio between the constitutional units represented by the general formulae (I-a) to (I-d) and the constitutional unit represented by the general formula (II) (general formulae (I-a) to (I-d)/general formula (II)) is 100/0 to 30/70.

15. The method for producing a magnetic disk substrate according to claim 4, wherein the polymer having an anionic group contained in the polishing liquid composition B used in the step (2) has a weight-average molecular weight of 500 or more and 120,000 or less.

16. The method for producing a magnetic disk substrate according to claim 5, wherein the heterocyclic aromatic compound contained in the polishing liquid composition B used in the step (2) is 1H-tetrazole, 1H-benzotriazole, 1H-tolyltriazole, or pyrazole.

17. The method for producing a magnetic disk substrate according to claim 6, wherein the polyamine compound content of the polishing liquid composition B used in the step (2) is 0.001 wt % or more and 10 wt % or less.

18. The method for polishing a magnetic disk substrate according to claim 8, further comprising, between the steps (1) and (2), the step of rinsing the substrate to be polished.
